(19) United States
(12) Patent Application Publication
(10) Pub. No.: US 2022/0315820 A1
(43) Pub. Date: Oct. 6, 2022

(54) SHAPED ABRASIVE PARTICLES WITH SHARP EDGES, METHODS OF MANUFACTURING AND ARTICLES CONTAINING THE SAME

(71) Applicant: 3M INNOVATIVE PROPERTIES COMPANY, St. Paul, MN (US)

(72) Inventors: Fay T. Salmon, Eden Prairie, MN (US); Cory M. Arthur, Eagan, MN (US); David T. Buckley, Falcon Heights, MN (US); Thomas J. Nelson, Woodbury, MN (US); Joseph B. Eckel, Vadnais Heights, MN (US); Emily L. Bowen, St. Paul, MN (US); Alireza Ghaderi, Woodbury, MN (US); Dwight D. Erickson, Woodbury, MN (US); Wayne W. Maurer, Lakeville, MN (US)

(21) Appl. No.: 17/597,735

(22) PCT Filed: Jul. 14, 2020
(86) PCT No.: PCT/IB2020/056601

§ 371 Date: Jan. 21, 2022

Related U.S. Application Data
(60) Provisional application No. 62/877,443, filed on Jul. 23, 2019.

(51) Int. Cl. C09K 3/14; C01F 7/447; B28B 7/00; B28B 1/14

(52) U.S. Cl. CPC C09K 3/1409; C01F 7/447; B28B 7/0029; B28B 1/14

(57) ABSTRACT

A method of manufacturing a shaped abrasive particle is disclosed. The method includes filling a cavity of a tool with an abrasive particle precursor material. The cavity has at least an interior surface that extends downward from a tool top surface at an angle. The method also includes leveling the abrasive particle precursor material such that a top surface of the abrasive particle precursor materials is flush with the tool surface, such that a sharp portion is formed along the intersection between the sloped wall of the tool cavity and the tool surface and the sharp portion is within the same plane as the tool surface. The method also includes removing a dried abrasive particle precursor from the cavity of the tool. The abrasive particle has a sharp portion formed along the intersection between the interior surface and the tool surface.

### BACKGROUND

Abrasive particles and abrasive articles including the abrasive particles are useful for abrading, finishing, or grinding a wide variety of materials and surfaces in the manufacturing of goods. As such, there continues to be a need for improving the cost, performance, or life of abrasive particles or abrasive articles.

### SUMMARY OF THE DISCLOSURE

Various embodiments disclosed relate to a shaped abrasive particle with a first face and a second face. The shaped abrasive particle has a first face and a second face. The first face and the second face are separated by a thickness. The second face has a different shape than the first face. A sharp portion defined by an interface between a third face and the first face. The third face extends from the second face to the first face, wherein the second face is polygonal in shape.

A method of manufacturing a shaped abrasive particle is disclosed. The method includes filling a cavity of a tool with an abrasive particle precursor material. The cavity has at least an interior surface that extends downward from a tool top surface at an angle. The method also includes leveling the abrasive particle precursor material such that a top surface of the abrasive particle precursor materials is flush with the tool surface, such that a sharp portion is formed along the intersection between the sloped wall of the tool cavity and the tool surface and the sharp portion is within the same plane as the tool surface. The method also includes removing a dried abrasive particle precursor from the cavity of the tool. The abrasive particle has a sharp portion formed along the intersection between the interior surface and the tool surface

There are many reasons to use the shaped abrasive particles and articles including the shaped abrasive particles made using methods described herein including the following non-limiting reasons. Shaped abrasive articles with sharp edges, such as those described herein, may be easier to manufacture than conventional shaped abrasive particles. Traditionally, the sharpness of a tip of a shaped abrasive grain was dependent on the cavity design of a tool, the release agent, and whether trapped air bubbles caused defects. Additionally, designing tool cavities becomes more difficult as the desired particle size decreases.

Methods described herein allow for manufacture of shaped abrasive particles with a sharp edge. By taking advantage of a tool surface, it is possible to create sharper portions, for example sharper tips or edges, than was previously possible with previously disclosed methods of making shaped abrasive particles. This can also allow for sharper edges on smaller particles while reducing the risk of defects.

### BRIEF DESCRIPTION OF THE FIGURES

The drawings illustrate generally, by way of example, but not by way of limitation, various embodiments discussed in the present document.

FIG. 1 is a close-up view of a shaped abrasive particle.

FIGS. 2A-E illustrate a method of making a shaped abrasive particle with sharp edges in an embodiment of the present invention.

FIGS. 2F and 2G illustrate geometries of shaped abrasive particles according to embodiments of the present invention.

FIG. 2H illustrates a radius of curvature of an abrasive particle.

FIGS. 3A-3E illustrate examples of shaped abrasive particles in some embodiments of the present invention.

FIG. 4 illustrates a method of abrading a workpiece in an embodiment of the present invention.

FIG. 5 illustrates a method and tool for making three dimensional shaped abrasive particles with sharp edges in an embodiment of the present invention.

FIGS. 6A and 6B show example shaped abrasive particles with sharp edges in some embodiments of the present invention.

FIGS. 6C and 6D show an example shaped abrasive particle with a sharp edge abrading a workpiece in an embodiment of the present invention.

FIG. 7A illustrates a sectional view of a coated abrasive article in an embodiment of the present invention.

FIGS. 7B-7D illustrate different orientation angles for particles within a coated abrasive article.

FIGS. 8A and 8B illustrate differences in sharpness between prior art shaped particles and particles made in some embodiments of the present invention.

FIGS. 9A-9B illustrate dimensions of mold cavities and resultant abrasive particles made in accordance with embodiments of the present invention.

FIGS. 10A-10D illustrate comparative cut efficacy of abrasive particles according to embodiments of the present invention compared to prior art abrasive particles.

FIGS. 11A-11C illustrate progressive fracturing of particles described herein.

FIGS. 12A-12C illustrate force responses for particles herein.

### DETAILED DESCRIPTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

As used herein, the term “shaped abrasive particle,” means an abrasive particle with at least a portion of the abrasive particle having a predetermined shape that is replicated from a mold cavity used to form the shaped precursor abrasive particle. Except in the case of abrasive shards (e.g. as described in US Patent Application Publication Nos. 2009/0169816 and 2009/0165394), the shaped abrasive particle will generally have a predetermined geometric shape that substantially replicates the mold cavity that was used to form the shaped abrasive particle. Shaped abrasive particle as used herein excludes abrasive particles obtained by a mechanical crushing operation. Suitable examples for geometric shapes having at least one vertex include polygons (including equilateral, equiangular, star-shaped, regular and irregular polygons), lens-shapes, lune-shapes, circular shapes, semicircular shapes, oval shapes, circular sectors, circular segments, drop-shapes and hypocycloids (for example super elliptical shapes).

For the purposes of this invention geometric shapes are also intended to include regular or irregular polygons or stars wherein one or more edges (parts of the perimeter of the face) can be arcuate (either of towards the inside or towards the outside, with the first alternative being preferred). Hence, for the purposes of this invention, triangular shapes also include three-sided polygons wherein one or more of the edges (parts of the perimeter of the face) can be arcuate, i.e., the definition of triangular extends to spherical triangles and the definition of quadrilaterals extends to superellipses. The second side may comprise (and preferably is) a second face. The second face may have a perimeter of a second geometric shape.

For the purposes of this invention, shaped abrasive particles also include abrasive particles comprising faces with different shapes, for example on different faces of the abrasive particle. Some embodiments include shaped abrasive particles with different shaped opposing sides. The different shapes may include, for example, differences in surface area of two opposing sides, or different polygonal shapes of two opposing sides.

The shaped abrasive particles are typically selected to have an edge length in a range of from 0.001 mm to 26 mm, more typically 0.1 mm to 10 mm, and more typically 0.5 mm to 5 mm, although other lengths may also be used.

The shaped abrasive particle may have a “sharp portion” which is used herein to describe either a sharp tip or a sharp edge of an abrasive article. The sharp portion may be defined using a radius of curvature, which is understood in this disclosure, for a sharp point, to be the radius of a circular arc which best approximates the curve at that point. For a sharp edge, the radius of curvature is understood to be the radius of the curvature of the profile of the edge on the plane perpendicular to the tangent direction of the edge. Further, the radius of curvature is the radius of a circle which best fits a normal section, or an average of sections measured, along the length of the sharp edge. The smaller a radius of curvature, the sharper the sharp portion of the abrasive particle.

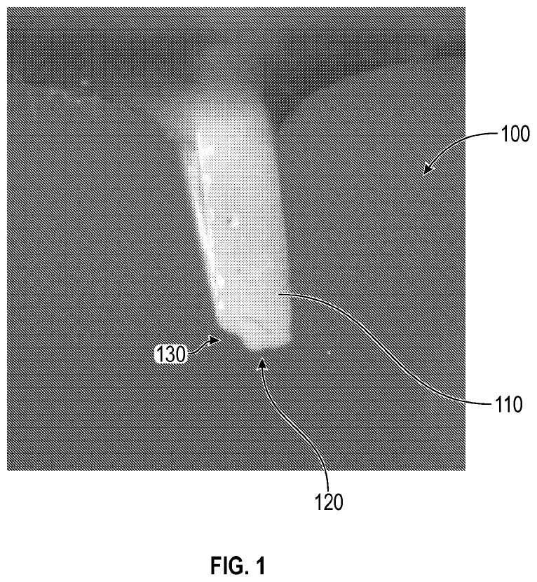

FIG. 1 is a close up side-view of a shaped abrasive particle with a defect. FIG. 1 illustrates an image 100 of a shaped abrasive particle 110. The shaped abrasive particle 110 was formed, for example, using methods described in U.S. Pat. No. 5,201,916, to Berg et al. For example, shaped abrasive particle 110 has an edge 120 that is formed as a precursor material contacts and dries along interior edge of a corresponding tool (not shown). However, edge 120 has a defect 130. Missing portions like defect 130 can be caused by bubbles that form during the process of filling a tool with precursor material, which result in tool-side defects like defect 130. Efforts have been undertaken to reduce surface tension of a tool in order to reduce bubble formation. However, the problem persists and is compounded for smaller sizes of shaped abrasive particles. It is desired to have a particle with a sharp edge that is not depending on corners or edges of a tool cavity. Particles described herein have sharp edges formed partially independently from an internal tool cavity. Instead, particles described herein have sharp edges formed when precursor material is made flush with a tool cavity surface, usually using a wiper or scraper tool.

A significant advantage of shaped abrasive particles over conventional crushed abrasive particles is the ability to precisely shape a cutting edge of particles. Precision shaped cutting edges can increase overall abrading performance of an abrasive article incorporating such shaped particles. However, when abrasive particles have defects, like missing portion 130, performance is affected.

Because the geometry of prior art molded abrasive particles are inherently dependent on the internal geometry of the mold, it has been difficult to create shaped abrasive particles with very sharp edges, especially at smaller particle sizes. Shaped abrasive particles described herein take advantage of methods described herein to produce shaped abrasive particles with sharp portions having smaller radii of curvature than previously achievable.

Embodiments herein describe shaped abrasive particles with sharp edges. The shaped abrasive particles are designed to have at least one sharp edge. Because the entire edge is designed to be sharp, instead of a single corner, the abrasive particle may provide improved abrading efficiency. Additionally, methods of manufacturing described herein illustrate how shaped abrasive particles can be formed with sharp edges consistently, without risk of defects like missing portion 130.

Shaped Abrasive Particles with Sharp Edges and Methods of Making the Same

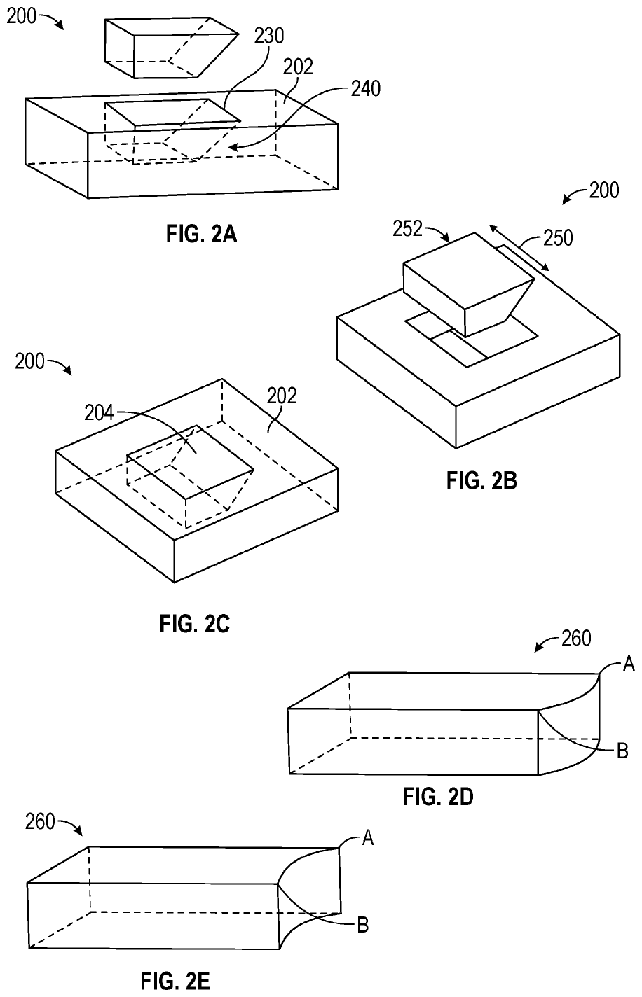

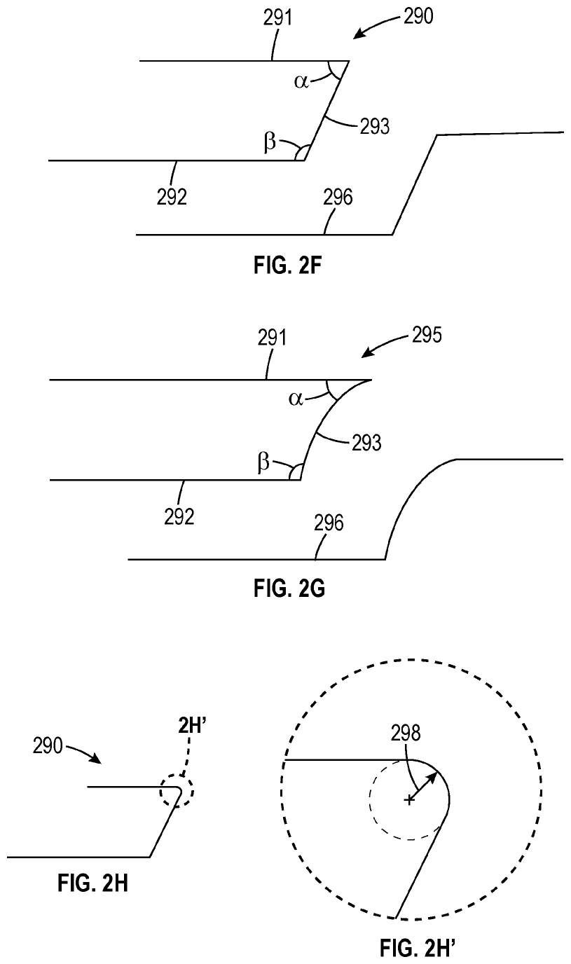

FIGS. 2A-2E illustrates a method of making shaped abrasive particles with a sharp edge in an embodiment of the present invention. Method 200 can be used to create shaped particles 260 with a sharp edge, for example using one or more tools 202.

FIG. 2A illustrates a tool 202 that contains a cavity 204. Cavity 204 is defined by one or more internal edges 240, and one or more surface edges 230. Cavity 204 may be shaped as the negative image of a polygon, such that a polygonal-shaped abrasive particle is formed. Surface edge 230 is an intersection of cavity 204 and a surface of tool 202, in one embodiment.

FIG. 2B illustrates a cavity 204 filled with an abrasive particle precursor material—e.g. a sol gel or a slurry, for example. Once filled, cavity 204 is leveled off, for example using a scraper or leveler, such that the shaped abrasive particle precursor is flush with a top surface of tool 202. Corners A and B, along with edge AB are in the same plane as surface of tool 202.

FIG. 2B illustrates a shaped abrasive particle 260 removed from tool 202. Shaped abrasive particle precursor may undergo a preliminary drying step prior to removal. Shaped abrasive particle 260 has a sharp edge 250 (e.g. corresponding to edge AB) and one or more sharp corners 252 (e.g. corners A and B). Sharp edge 250 and corners 252 are formed on the shape of cavity 204 in combination with how it is filled. The leveling step shown in FIG. 2B causes precursor material to fill cavity 204 up to surface edge 230, such that precursor material is flush with the surface of tool 202. And, because edge 230 is at a surface of cavity 204, it is less susceptible to wicking effects that could cause defects in shaped abrasive particle 260 as, for example, along internal edge 240.

While FIGS. 2A-2C illustrate a shaped abrasive particle 260 with a straight edge 250, it is to be understood that other particle shapes with sharp edges may also be possible. For example, FIGS. 2D and 2E illustrate shaped abrasive particles 260 that could be formed in the instance where edge AB is convex (e.g. resulting in the particle of FIG. 2E) or concave (e.g. resulting in the particle of FIG. 2D).

Previous attempts at forming shaped abrasive particles with sharp edges involved modifying the internal geometry of a tool cavity and release agent chemistry to encourage full wetting of the surface area of the tool cavity and subsequent release of a formed particle after an initial drying step. However, as illustrated by the defective shaped abrasive particle in FIG. 1, bubble formation is still possible.

Using method 200, shaped abrasive particles 260 can be made with sharp edges 230. The cutting edge 230 is formed independent of a release agent. And while the shape of tool 202 may dictate an angle of edge 230, the sharpness of edge 230 is caused by the leveling off of precursor material within cavity 204. Causing the material to be flush with the surface of tool 202 forms a consistent sharp edge 230.

While many previous efforts in designing shaped abrasive particles have focused on forming sharp cutting tips, method 200 creates a shaped abrasive particle with a sharp portion, for example sharp edge 230. A radius of curvature dictating the sharpness of edge 230 can, using method 200, be consistent along the entire edge, not just at corners A and B illustrated in FIG. 2. The availability of an entire cutting edge 230, instead of a single cutting point, allows for more efficient abrading of a workpiece. However, while sharp cutting edge 230 is illustrated, similar methods can also be used to create especially sharp cutting tips at a vertex of a polygonal face.

Because the sharp cutting edge created using method 200 is formed independent of release agent chemistry, and somewhat independent of internal cavity geometry, method 200 can accommodate a variety of internal cavity structures allowing for sharper edges on a variety of sizes of shaped abrasive particles.

While method 200 is described and illustrated with a straight edge 230 extending between points A and B, it is also possible that edge 230 could have some curvature, such that two points, e.g. at corners A and B, are present in the same cutting plane. The curvature of edge 230 could be either concave or convex as illustrated in FIGS. 2D and 2E.

FIGS. 2F and 2G illustrate geometries of shaped abrasive particles according to embodiments of the present invention FIGS. 2F and 2G illustrate embodiments of different particles 290 which may be created using method 200, made using a mold with a cavity profile 295 (FIG. 2F) or cavity profile 296 (FIG. 2G).

FIG. 2F illustrates a shaped abrasive particle 290 made using a cavity with a mold profile 295. Shaped abrasive particle 290 has three faces called out in the profile illustrated in FIG. 2F. Face 292 and face 293 are formed to be a negative image of cavity profile 295. An angle β is created at the intersection of faces 292 and 293. Angle β has been an area of previous development in forming sharper abrasive particles. However, particularly for smaller particle sizes, ensuring that the mold cavity is completely wetted at angle β by a precursor material is a difficult problem, often resulting in defects similar to that illustrated in FIG. 1.

Angle β is an obtuse angle. In one embodiment, angle β is greater than about 135°. However, other angles are also possible. For example, angle β could be an angle greater than about 135°, or greater than about 140°, or greater than about 145°, or greater than about 150°, or greater than about 155°, or greater than about 160°, or greater than about 165°, or greater than about 170°.

Face 291 is formed independently of mold cavity profile 295. Instead, face 291 is formed during the leveling step illustrated in FIG. 2B. Face 291 forms an angle α with face 293. Angle α is an acute angle. Angle α can be as small as about 10°. In one embodiment, angle α is between 7-50°. In a preferred embodiment, angle α is less than 60°.

FIG. 2G differs from FIG. 2F in that face 293 has curvature. This may allow for an even smaller angle α, and a larger angle β, than with respect to the embodiment of FIG. 2F.

FIG. 2H illustrates an example radius of curvature calculation 297 for a particle 290. The radius of curvature 298 is the radius of the smallest circle that, when viewed in a direction orthogonal to the open face of the shaped abrasive particle including the open face tip, passes through a point on each of the two sides of the open face of the shaped abrasive particle that come together to form the tip at the start of a curve of the tip where each of the two sides transition from straight to curved. The sharp edge of shaped abrasive particles described in at least some embodiments herein can have a radius of curvature two or more times less (i.e. sharper) than particles made by previously disclosed methods of making shaped abrasive particles. For example, the radius of curvature may be as low as 7 μm as compared with previous methods which yielded radii of curvature 14 μm or higher.

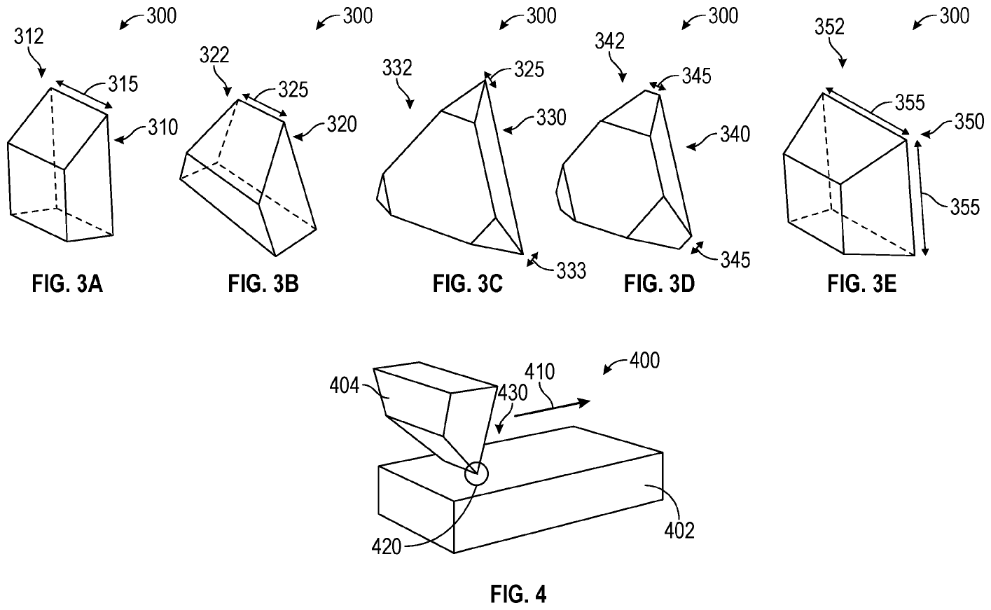

FIGS. 3A-3E illustrate examples of shaped abrasive particles in accordance with embodiments of the present invention. Shaped abrasive particles 300 can be made using, for example, method 200 described above, or through another suitable method. Additionally, while a selection of shaped abrasive particles 300 are illustrated, it is to be understood that other shapes are also possible using methods described herein.

FIG. 3A illustrates a trapezoidal shaped abrasive particle 312 with a sharp edge 315. Sharp edge 315 is created by leveling precursor material along surface 310. Sharp edge 315, as discussed in greater detail below, may have a preferred abrading orientation and may have different abrading properties depending on whether surface 310 is leading or trailing during an abrading operation. Orientation of the abrasive particles in coated abrasive articles generally has an influence on abrading properties. In the instance that the abrasive particles are precisely-shaped (e.g., into triangular platelets or conical particles), this effect of orientation can be especially important as discussed in U. S. Pat. Appl. Publ. No. 2013/0344786 A1 (Keipert), incorporated by reference herein.

FIG. 3B illustrates another embodiment of a trapezoidal shaped abrasive particle 322 with a cutting edge 325. Cutting edge 325 is formed by a scraper or other utensil leveling precursor material such that surface 320 is flush with a surface of a corresponding tool (not shown).

FIG. 3C illustrates one embodiment of a triangular shaped abrasive particle 332 with three cutting points 333. The three corners of triangular shaped abrasive particle 332 are beveled, such that cutting points 333 are made sharp when a precursor material is wiped flush with a corresponding tool along surface 330.

FIG. 3D illustrates another embodiment of a triangular shaped abrasive particle 342, with sharp edges 345 instead of tips. Sharp edges 345 are formed in part by a tool with a corresponding cavity shape, with beveled corner portions. Sharp edges 345 are formed as surface 340 is leveled flush with a surface of a corresponding tool.

FIG. 3E illustrates another trapezoidal shaped abrasive particle 352 with multiple sharp edges 355. Edges 355 are made sharp because a scraper, or other leveling utensil, removes extra precursor material, leaving a surface 350 of the precursor material flush with a corresponding tool surface.

In one embodiment, a shaped abrasive particle can be described as having a first face and a second face separated by a thickness. One face may have a shape dictated by the internal geometry of a mold cavity. An opposing face may be formed during a leveling step, for example, as described in FIG. 2B above. As illustrated in FIGS. 3A-3E, shaped abrasive particles can have any one of several potential polygon-shaped faces. Additionally, the shape of two opposing faces can be the same (e.g. as in FIG. 3A where opposing faces are both trapezoidal) or different (e.g. as in FIG. 3C, where a hexagonal face opposes a triangular face).

However, it is also expressly contemplated that other embodiments include other shapes. For example, a tetrahedral shaped particle may be formed from a mold cavity with an internal vertex, such that the base of the tetrahedral is formed during a leveling step, with four equivalent sharp edges and sharp tips. Irregular tetrahedrons, as well as other polygonal shapes, are also envisioned. Such embodiments could be described, for example as having a sharp point separated from a face by a thickness, t.

Any one of the surfaces of a shaped abrasive particle can include a surface feature such as a substantially planar surface; a substantially planar surface having a triangular, rectangular, hexagonal, or other polygonal perimeter; a concave surface; a convex surface; an aperture; a ridge; a line or a plurality of lines; a protrusion; a point; or a depression. The surface feature can be chosen to change the cut rate, reduce wear of the formed abrasive particles, or change the resulting finish of an abrasive article. Additionally, a shaped abrasive particle 300 can have a combination of the above shape elements (e.g., convex sides, concave sides; irregular sides, and planar sides).

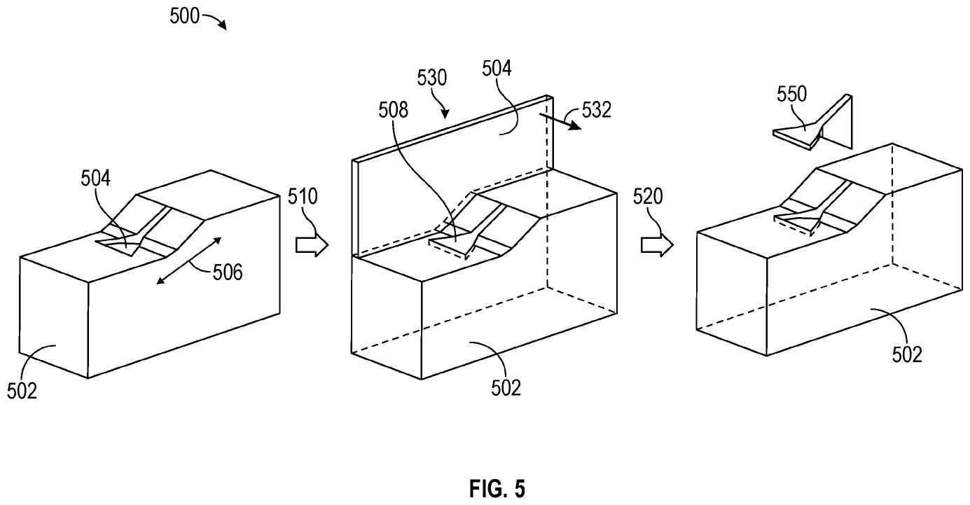

The shaped abrasive particles can have at least one sidewall, which may be a sloping sidewall. In some embodiments, more than one (for example two or three) sloping sidewall can be present and the slope or angle for each sloping sidewall may be the same or different. In other embodiments, the sidewall can be minimized for particles where the first and the second faces taper to a thin edge or point where they meet instead of having a sidewall. The sloping sidewall can also be defined by a radius, R (as illustrated in FIG. 5B of US Patent Application No. 2010/0151196). The radius; R, can be varied for each of the sidewalls.

Specific examples of shaped particles having a ridge line include roof-shaped particles, for example particles as illustrated, in FIG. 4A to 4C of WO 2011/068714. Preferred; roof-shaped particles include particles having the shape of a hip roof, or hipped roof (a type of roof wherein any sidewalls facets present slope downwards from the ridge line to the first side. A hipped roof typically does not comprise vertical sidewall(s) or facet(s)).

Shaped abrasive particles can have one or more shape features selected from: an opening (preferably one extending or passing through the first and second side); at least one recessed (or concave) face or facet; at least one face or facet which is shaped outwardly (or convex); at least one side comprising a plurality of grooves; at least one fractured surface; a cavity, a low roundness factor; or a combination of one or more of said shape features.

Shaped abrasive particles 300 can also comprise a plurality of ridges on their surfaces. The plurality of grooves (or ridges) can be formed by a plurality of ridges (or grooves) in the bottom surface of a mold cavity that have been found to make it easier to remove the precursor shaped abrasive particles from the mold.

The plurality of grooves (or ridges) is not particularly limited and can, for example, comprise parallel lines which may or may not extend completely across the side. Preferably, the parallel lines intersect with the perimeter along a first edge at a 90° angle. The cross-sectional geometry of a groove or ridge can be a truncated triangle, triangle, or other geometry as further discussed in the foil owing. In various embodiments of the invention, the depth, of the plurality of grooves can be between about 1 micrometer to about 400 micrometers.

According to another embodiment the plurality of grooves comprises a cross hatch pattern of intersecting parallel lines which may or in ay not extend completely across the face. In various embodiments, the cross hatch pattern can use intersecting parallel or non-parallel lines, various percent spacing between the lines, arcuate intersecting lines, or various cross-sectional geometries of the grooves. In other embodiments the number of ridges (or grooves) in the bottom surface of each mold cavity can be between 1 and about 100, or between 2 to about 50, or between about 4 to about 25 and thus form a corresponding number of grooves (or ridges) in the shaped abrasive particles.

Methods for making shaped abrasive particles having at least one sloping sidewall are for example described in US Patent Application Publication No. 2009/0165394. Methods for making shaped abrasive particles having an opening are for example described in US Patent Application Publication No. 2010/0151201 and 2009/0165394. Methods for making shaped abrasive particles having grooves on at least one side are for example described in US Patent Application Publication No. 2010/0146867. Methods for making dish-shaped abrasive particles are for example described in US Patent Application Publication Nos. 2010/0151195 and 2009/0165394. Methods for making shaped abrasive particles with low Roundness Factor are for example described in US Patent Application Publication No. 2010/0319269. Methods for making shaped abrasive particles with at least one fractured surface are for example described in US Patent Application Publication Nos. 2009/0169816 and 2009/0165394. Methods fix making abrasive particles wherein the second side comprises a vertex (for example, dual tapered abrasive particles) or a ridge line (for example, roof shaped particles) are for example described in WO 2011/068714.

Methods of Manufacturing Shaped Abrasive Particles with Sharp Edges

Shaped abrasive particles 300 can be formed from many suitable materials or combinations of materials. For example, shaped abrasive particles 300 can comprise a ceramic material or a polymeric material. If a shaped abrasive particle 300 comprises a ceramic material, the ceramic material can include alpha alumina, sol-gel derived alpha alumina, or a mixture thereof. Other suitable materials include a fused aluminum oxide, a heat-treated aluminum oxide, a ceramic aluminum oxide, a sintered aluminum oxide, a silicon carbide material, a titanium diboride, a boron carbide, a tungsten carbide, a titanium carbide, a diamond, a cubic boron nitride, a garnet, a fused alumina-zirconia, a cerium oxide, a zirconium oxide, a titanium oxide or a combination thereof.

Shaped abrasive particles 300 that include a polymeric material can be characterized as soft abrasive particles. The soft shaped abrasive particles described herein can include any suitable material or combination of materials. For example, the soft shaped abrasive particles can include a reaction product of a polymerizable mixture including one or more polymerizable resins. The one or more polymerizable resins are chosen from a phenolic resin, a urea formaldehyde resin, a urethane resin, a melamine resin, an epoxy resin, a bismaleimide resin, a vinyl ether resin, an aminoplast resin (which may include pendant alpha, beta unsaturated carbonyl groups), an acrylate resin, an acrylated isocyanurate resin, an isocyanurate resin, an acrylated urethane resin, an acrylated epoxy resin, an alkyl resin, a polyester resin, a drying oil, or mixtures thereof. The polymerizable mixture can include additional components such as a plasticizer, an acid catalyst, a cross-linker, a surfactant, a mild-abrasive, a pigment, a catalyst and an antibacterial agent.

Where multiple components are present in the polymerizable mixture, those components can account for any suitable weight percentage of the mixture. For example, the polymerizable resin or resins, may be in a range of from about 35 wt % to about 99.9 wt % of the polymerizable mixture, about 40 wt % to about 95 wt %, or less than, equal to, or greater than about 35 wt %, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, or about 99.9 wt %.

If present, the cross-linker may be in a range of from about 2 wt % to about 60 wt % of the polymerizable mixture, from about 5 wt % to about 10 wt %, or less than, equal to, or greater than about 2 wt %, 3, 4, 5, 6, 7, 8, 9, 10, 11, 12, 13, 14, or about 15 wt %. Examples of suitable cross-linkers include a cross-linker available under the trade designation CYMEL 303 LF, of Allnex USA Inc., Alpharetta, Ga., USA; or a cross-linker available under the trade designation CYMEL 385, of Allnex USA Inc., Alpharetta, Ga., USA.

If present, the mild-abrasive may be in a range of from about 5 wt % to about 65 wt % of the polymerizable mixture, about 10 wt % to about 20 wt %, or less than, equal to, or greater than about 5 wt %, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, or about 65 wt %. Examples of suitable mild-abrasives include a mild-abrasive available under the trade designation MINSTRON 353 TALC, of Imerys Talc America, Inc., Three Forks, Mont., USA; a mild-abrasive available under the trade designation USG TERRA ALBA NO. 1 CALCIUM SULFATE, of USG Corporation, Chicago, Ill., USA; Recycled Glass (40-70 Grit) available from ESCA Industries, Ltd., Hatfield, Pa., USA, silica, calcite, nepheline, syenite, calcium carbonate, or mixtures thereof.

If present, the plasticizer may be in a range of from about 5 wt % to about 40 wt % of the polymerizable mixture, about 10 wt % to about 15 wt %, or less than, equal to, or greater than about 5 wt %, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or about 40 wt %. Examples of suitable plasticizers include acrylic resins or styrene butadiene resins. Examples of acrylic resins include an acrylic resin available under the trade designation RHOPLEX GL-618, of DOW Chemical Company, Midland, Mich., USA; an acrylic resin available under the trade designation HYCAR 2679, of the Lubrizol Corporation, Wickliffe, Ohio, USA; an acrylic resin available under the trade designation HYCAR 26796, of the Lubrizol Corporation, Wickliffe, Ohio, USA; a polyether polyol available under the trade designation ARCOL LG-650, of DOW Chemical Company, Midland, Mich., USA; or an acrylic resin available under the trade designation HYCAR 26315, of the Lubrizol Corporation, Wickliffe, Ohio, USA. An example of a styrene butadiene resin includes a resin available under the trade designation ROVENE 5900, of Mallard Creek Polymers, Inc., Charlotte, N.C., USA.

If present, the acid catalyst may be in a range of from 0.1 wt % to about 20 wt % of the polymerizable mixture, about 5 wt % to about 10 wt %, or less than, equal to, or greater than about 0.1 wt %, 0.5, 1, 2, 3, 4, 5, 6, 7, 8, 9, 10, 11, 12, 13, 14, 15, 16, 17, 18, 19, or about 20 wt %. Examples of suitable acid catalysts include a solution of aluminum chloride or a solution of ammonium chloride.

If present, the surfactant can be in a range of from about 0.001 wt % to about 15 wt % of the polymerizable mixture about 5 wt % to about 10 wt %, less than, equal to, or greater than about 0.001 wt %, 0.01, 0.5, 1, 2, 3, 4, 5, 6, 7, 8, 9, 10, 11, 12, 13, 14, or about 15 wt %. Examples of suitable surfactants include a surfactant available under the trade designation GEMTEX SC-85-P, of Innospec Performance Chemicals, Salisbury, N.C., USA; a surfactant available under the trade designation DYNOL 604, of Air Products and Chemicals, Inc., Allentown, Pa., USA; a surfactant available under the trade designation ACRYSOL RM-8W, of DOW Chemical Company, Midland, Mich., USA; or a surfactant available under the trade designation XIAMETER AFE 1520, of DOW Chemical Company, Midland, Mich., USA.

If present, the antimicrobial agent may be in a range of from 0.5 wt % to about 20 wt % of the polymerizable mixture, about 10 wt % to about 15 wt %, or less than, equal to, or greater than about 0.5 wt %, 1, 2, 3, 4, 5, 6, 7, 8, 9, 10, 11, 12, 13, 14, 15, 16, 17, 18, 19, or about 20 wt %. An example of a suitable antimicrobial agent includes zinc pyrithione.

If present, the pigment may be in a range of from about 0.1 wt % to about 10 wt % of the polymerizable mixture, about 3 wt % to about 5 wt %, less than, equal to, or greater than about 0.1 wt %, 0.2, 0.4, 0.6, 0.8, 1, 1.5, 2, 2.5, 3, 3.5, 4, 4.5, 5, 5.5, 6, 6.5, 7, 7.5, 8, 8.5, 9, 9.5, or about 10 wt %. Examples of suitable pigments include a pigment dispersion available under the trade designation SUNSPERSE BLUE 15, of Sun Chemical Corporation, Parsippany, N.J., USA; a pigment dispersion available under the trade designation SUNSPERSE VIOLET 23, of Sun Chemical Corporation, Parsippany, N.J., USA; a pigment dispersion available under the trade designation SUN BLACK, of Sun Chemical Corporation, Parsippany, N.J., USA; or a pigment dispersion available under the trade designation BLUE PIGMENT B2G, of Clariant Ltd., Charlotte, N.C., USA.

In addition to the materials already described, at least one magnetic material may be included within or coated to a shaped abrasive particle 300. Examples of magnetic materials include iron; cobalt; nickel; various alloys of nickel and iron marketed as Permalloy in various grades; various alloys of iron, nickel and cobalt marketed as Fernico, Kovar, FerNiCo I, or FerNiCo II; various alloys of iron, aluminum, nickel, cobalt, and sometimes also copper and/or titanium marketed as Alnico in various grades; alloys of iron, silicon, and aluminum (about 85:9:6 by weight) marketed as Sendust alloy; Heusler alloys (e.g., Cu2MnSn); manganese bismuthide (also known as Bismanol); rare earth magnetizable materials such as gadolinium, dysprosium, holmium, europium oxide, alloys of neodymium, iron and boron (e.g., Nd₂Fe₁₄B), and alloys of samarium and cobalt (e.g., SmCo₅); MnSb; MnOFe₂O₃; Y3Fe₅O₁₂; CrO₂; MnAs; ferrites such as ferrite, magnetite, zinc ferrite; nickel ferrite; cobalt ferrite, magnesium ferrite, barium ferrite, and strontium ferrite; yttrium iron garnet; and combinations of the foregoing. In some embodiments, the magnetizable material is an alloy containing 8 to 12 weight percent aluminum, 15 to 26 wt % nickel, 5 to 24 wt % cobalt, up to 6 wt % copper, up to 1% titanium, wherein the balance of material to add up to 100 wt % is iron. In some other embodiments, a magnetizable coating can be deposited on an abrasive particle 100 using a vapor deposition technique such as, for example, physical vapor deposition (PVD) including magnetron sputtering.

Including these magnetizable materials can allow a shaped abrasive particle 300 to be responsive a magnetic field. Any of shaped abrasive particles 300 can include the same material or include different materials.

Shaped abrasive particle 300 is a monolithic abrasive particle. As shown, shaped abrasive particle 300 is free of a binder and is not an agglomeration of abrasive particles held together by a binder or other adhesive material.

Shaped abrasive particles 300 can be formed in many suitable manners for example, the shaped abrasive particles 300 can be made according to a multi-operation process. The process can be carried out using any material or precursor dispersion material. Briefly, for embodiments where shaped abrasive particles 300 are monolithic ceramic particles, the process can include the operations of making either a seeded or non-seeded precursor dispersion that can be converted into a corresponding (e.g., a boehmite sol-gel that can be converted to alpha alumina); filling one or more mold cavities having the desired outer shape of shaped abrasive particle 300 with a precursor dispersion; drying the precursor dispersion to form precursor shaped abrasive particle; removing the precursor shaped abrasive particle 300 from the mold cavities; calcining the precursor shaped abrasive particle 300 to form calcined, precursor shaped abrasive particle 300; and then sintering the calcined, precursor shaped abrasive particle 300 to form shaped abrasive particle 300. The process will now be described in greater detail in the context of alpha-alumina-containing shaped abrasive particle 300. In other embodiments, the mold cavities may be filled with a melamine to form melamine shaped abrasive particles.

The process can include the operation of providing either a seeded or non-seeded dispersion of a precursor that can be converted into ceramic. In examples where the precursor is seeded, the precursor can be seeded with an oxide of an iron (e.g., FeO). The precursor dispersion can include a liquid that is a volatile component. In one example, the volatile component is water. The dispersion can include a sufficient amount of liquid for the viscosity of the dispersion to be sufficiently low to allow filling mold cavities and replicating the mold surfaces, but not so much liquid as to cause subsequent removal of the liquid from the mold cavity to be prohibitively expensive. In one example, the precursor dispersion includes from 2 percent to 90 percent by weight of the particles that can be converted into ceramic, such as particles of aluminum oxide monohydrate (boehmite), and at least 10 percent by weight, or from 50 percent to 70 percent, or 50 percent to 60 percent, by weight, of the volatile component such as water. Conversely, the precursor dispersion in some embodiments contains from 30 percent to 50 percent, or 40 percent to 50 percent solids by weight.

Examples of suitable precursor dispersions include zirconium oxide sols, vanadium oxide sols, cerium oxide sols, aluminum oxide sols, and combinations thereof. Suitable aluminum oxide dispersions include, for example, boehmite dispersions and other aluminum oxide hydrates dispersions. Boehmite can be prepared by known techniques or can be obtained commercially. Examples of commercially available boehmite include products having the trade designations “DISPERAL” and “DISPAL”, both available from Sasol North America, Inc., or “HIQ-40” available from BASF Corporation. These aluminum oxide monohydrates are relatively pure; that is, they include relatively little, if any, hydrate phases other than monohydrates, and have a high surface area. Additionally, in some embodiments, suitable abrasive particle precursor materials include fine abrasive particles that, upon sintering, form a single abrasive particle. In some embodiments, the abrasive particle precursor materials can include, alone or in addition, fine alpha alumina particles that upon sintering fuse together to form a sintered alpha alumina ceramic body, e.g., as disclosed in U.S. Publ. Pat. Appln. No. 2016/0068729 A1 (Erickson et al.)

The materials that can be made into shaped abrasive particles include any suitable hard or superhard material known to be suitable for use as an abrasive particle. Accordingly, in one embodiment, the shaped abrasive particles comprise a hard abrasive material. In another embodiment, the shaped abrasive particles comprise a superhard abrasive material. In yet other embodiments, the shaped abrasive particles comprise a combination of hard and superhard materials. Specific examples of suitable abrasive materials include known ceramic materials, carbides, nitrides and other hard and superhard materials such as aluminum oxide (for example alpha alumina) materials (including fused, heat treated, ceramic and sintered aluminum oxide materials), silicon carbide, titanium diboride, titanium nitride, boron carbide, tungsten carbide, titanium carbide, diamond, cubic boron nitride (CBN), garnet, alumina-zirconia, sol-gel derived abrasive particles, cerium oxide, zirconium oxide, titanium oxide or a combination thereof.

The most useful of the above are typically based on aluminum oxide, and in the specific descriptions that follow the invention may be illustrated with specific reference to aluminum oxide. It is to be understood, however, that the invention is not limited to aluminum oxide but is capable of being adapted for use with a plurality of different hard and superhard materials. With respect to the three basic technologies for preparing shaped abrasive particles (i.e., fusion, sintering and chemical ceramic technologies), in the present invention, the shaped abrasive particles may be based on one or more material(s) prepared by any one of these technologies, i.e., on one or more fused, sintered, or ceramic materials, with a preferred material being aluminum oxide (preferably alpha aluminum oxide). In other words, preferred shaped abrasive particles according to the invention are based on alumina, i.e. such particles either consist of alumina or are comprised of a major portion thereof, such as for example greater than 50%, for example 55 to 100%, or 60 to 80%, more preferably 85 to 100% by weight of the total weight of the abrasive particle. The remaining portion may comprise any material which will not detract from the shaped abrasive particle acting as an abrasive, including but not limited to hard and superhard materials as outlined in the foregoing. In some preferred embodiments, the shaped abrasive particles consist of 100% aluminum oxide, in yet other preferred embodiments, the shaped abrasive particles comprise at least 60% by weight aluminum oxide or at least 70% by weight of aluminum oxide. Useful shaped abrasive particles may, for example, include but are not limited to particles which comprise a major portion (for example 50% or more and preferably 55% or more by weight) of fused aluminum oxide and a minor portion (for example, less than 50% and preferably less than 45 by weight) of an abrasive material different from fused aluminum oxide (for example zirconium oxide).

By way of example, a method suitable for use in the present invention comprises chemical ceramic technology involving converting a colloidal dispersion or hydrosol (sometimes called a sol), optionally in a mixture with solutions of other metal oxide precursors, to a gel or any other physical state that restrains the mobility of the components, drying, and firing to obtain a ceramic material A sol can be prepared by any of several methods, including precipitation of a metal hydroxide from an aqueous solution followed by peptization, dialysis of anions from a solution of metal salt, solvent extraction of an anion from a solution of a metal salt, hydrothermal decomposition of a solution of a metal salt having a volatile anion. The sol optionally contains metal oxide or precursor thereof and is transformed to a semirigid solid state of limited mobility such as a gel by, e.g., partial extraction of the solvent, e.g., water, the gel can be shaped by any convenient method such as pressing, molding, or extruding, to provide a shaped abrasive grain.

An exemplary method involving chemical ceramic technology comprises the steps of making a dimensionally stable dispersion of a ceramic precursor (which may for example include either a seeded or non-seeded sol-gel alpha alumina precursor dispersion that can be converted into alpha alumina); filling one or more mold cavities having the desired outer shape of the shaped abrasive particle with the dimensionally stable dispersion of a ceramic precursor, drying the stable dispersion of a ceramic precursor to form precursor ceramic shaped abrasive particles; removing the precursor ceramic shaped abrasive particles from the mold cavities; calcining the precursor ceramic shaped abrasive particles to form calcined, precursor ceramic shaped abrasive particles, and then sintering the calcined; precursor ceramic shaped abrasive particles to form ceramic shaped abrasive particles. The process is described in more detail in U.S. Pat. No. 5,201,916 (Berg et al).

The physical properties of the resulting shaped abrasive particles can generally depend upon the type of material used in the precursor dispersion. As used herein, a “gel” is a three-dimensional network of solids dispersed in a liquid.

The precursor dispersion can contain a modifying additive or precursor of a modifying additive. The modifying additive can function to enhance some desirable property of the abrasive particles or increase the effectiveness of the subsequent sintering step. Modifying additives or precursors of modifying additives can be in the form of soluble salts, such as water-soluble salts. They can include a metal-containing compound and can be a precursor of an oxide of magnesium, zinc, iron, silicon, cobalt, nickel, zirconium, hafnium, chromium, yttrium, praseodymium, samarium, ytterbium, neodymium, lanthanum, gadolinium, cerium, dysprosium, erbium, titanium, and mixtures thereof. The particular concentrations of these additives that can be present in the precursor dispersion can be varied.

The introduction of a modifying additive or precursor of a modifying additive can cause the precursor dispersion to gel. The precursor dispersion can also be induced to gel by application of heat over a period of time to reduce the liquid content in the dispersion through evaporation. The precursor dispersion can also contain a nucleating agent. Nucleating agents suitable for this disclosure can include fine particles of alpha alumina, alpha ferric oxide or its precursor, titanium oxides and titanates, chrome oxides, or any other material that will nucleate the transformation. The amount of nucleating agent, if used, should be sufficient to effect the transformation of alpha alumina.

A peptizing agent can be added to the precursor dispersion to produce a more stable hydrosol or colloidal precursor dispersion. Suitable peptizing agents are monoprotic acids or acid compounds such as acetic acid, hydrochloric acid, formic acid, and nitric acid. Multiprotic acids can also be used, but they can rapidly gel the precursor dispersion, making it difficult to handle or to introduce additional components. Some commercial sources of boehmite contain an acid titer (such as absorbed formic or nitric acid) that will assist in forming a stable precursor dispersion.

The precursor dispersion can be formed by any suitable means; for example, in the case of a sol-gel alumina precursor, it can be formed by simply mixing aluminum oxide monohydrate with water containing a peptizing agent or by forming an aluminum oxide monohydrate slurry to which the peptizing agent is added.

Defoamers or other suitable chemicals can be added to reduce the tendency to form bubbles or entrain air while mixing. Additional chemicals such as wetting agents, alcohols, or coupling agents can be added if desired.

A further operation can include providing a mold having at least one mold cavity, or a plurality of cavities formed in at least one major surface of the mold. In some examples, the mold is formed as a production tool, which can be, for example, a belt, a sheet, a continuous web, a coating roll such as a rotogravure roll, a sleeve mounted on a coating roll, or a die. In one example, the production tool can include polymeric material. Examples of suitable polymeric materials include thermoplastics such as polyesters, polycarbonates, poly(ether sulfone), poly(methyl methacrylate), polyurethanes, polyvinylchloride, polyolefin, polystyrene, polypropylene, polyethylene or combinations thereof, or thermosetting materials. In one example, the entire tooling is made from a polymeric or thermoplastic material. In another example, the surfaces of the tooling in contact with the precursor dispersion while the precursor dispersion is drying, such as the surfaces of the plurality of cavities, include polymeric or thermoplastic materials, and other portions of the tooling can be made from other materials. A suitable polymeric coating can be applied to a metal tooling to change its surface tension properties, by way of example.

A polymeric or thermoplastic production tool can be replicated off a metal master tool. The master tool can have the inverse pattern of that desired for the production tool. The master tool can be made in the same manner as the production tool. In one example, the master tool is made out of metal (e.g., nickel) and is diamond-turned. In one example, the master tool is at least partially formed using stereolithography. The polymeric sheet material can be heated along with the master tool such that the polymeric material is embossed with the master tool pattern by pressing the two together. A polymeric or thermoplastic material can also be extruded or cast onto the master tool and then pressed. The thermoplastic material is cooled to solidify and produce the production tool. If a thermoplastic production tool is utilized, then care should be taken not to generate excessive heat that can distort the thermoplastic production tool, limiting its life.

Access to cavities can be from an opening in the top surface or bottom surface of the mold. In some examples, the cavities can extend for the entire thickness of the mold. Alternatively, the cavities can extend only for a portion of the thickness of the mold. In one example, the top surface is substantially parallel to the bottom surface of the mold with the cavities having a substantially uniform depth. At least one side of the mold, the side in which the cavities are formed, can remain exposed to the surrounding atmosphere during the step in which the volatile component is removed.

The cavities have a specified three-dimensional shape to make shaped abrasive particles. The depth dimension is equal to the perpendicular distance from the top surface to the lowermost point on the bottom surface. The depth of a given cavity can be uniform or can vary along its length and/or width. The cavities of a given mold can be of the same shape or of different shapes.

A further operation involves filling the cavities in the mold with the precursor dispersion (e.g., by a conventional technique). In some examples, a knife roll coater or vacuum slot die coater can be used. A mold release agent can be used to aid in removing the particles from the mold if desired. Examples of mold release agents include oils such as peanut oil or mineral oil, fish oil, silicones, polytetrafluoroethylene, zinc stearate, and graphite. In general, a mold release agent such as peanut oil, in a liquid, such as water or alcohol, is applied to the surfaces of the production tooling in contact with the precursor dispersion such that from about 0.1 mg/in² (0.6 mg/cm²) to about 3.0 mg/in² (20 mg/cm²), or from about 0.1 mg/in² (0.6 mg/cm²) to about 5.0 mg/in² (30 mg/cm²), of the mold release agent is present per unit area of the mold when a mold release is desired. In some embodiments, the top surface of the mold is coated with the precursor dispersion. The precursor dispersion can be pumped onto the top surface.

In a further operation, a scraper or leveler bar can be used to force the precursor dispersion fully into the cavity of the mold. The remaining portion of the precursor dispersion that does not enter the cavity can be removed from the top surface of the mold and recycled. In some examples, a small portion of the precursor dispersion can remain on the top surface, and in other examples the top surface is substantially free of the dispersion. The pressure applied by the scraper or leveler bar can be less than 100 psi (0.6 MPa), or less than 50 psi (0.3 MPa), or even less than 10 psi (60 kPa). In some examples, no exposed surface of the precursor dispersion extends substantially beyond the top surface.

A further operation involves removing the volatile component to dry the dispersion. The volatile component can be removed by fast evaporation rates. In some examples, removal of the volatile component by evaporation occurs at temperatures above the boiling point of the volatile component. An upper limit to the drying temperature often depends on the material the mold is made from. For polypropylene tooling, the temperature should be less than the melting point of the plastic. In one example, for a water dispersion of from about 40 to 50 percent solids and a polypropylene mold, the drying temperatures can be from about 90° C. to about 165° C., or from about 105° C. to about 150° C., or from about 105° C. to about 120° C. Higher temperatures can lead to improved production speeds but can also lead to degradation of the polypropylene tooling, limiting its useful life as a mold.

During drying, the precursor dispersion shrinks, often causing retraction from the cavity walls. For example, if the cavities have planar walls, then the resulting shaped abrasive particle can tend to have at least three concave major sides. It is presently discovered that by making the cavity walls concave (whereby the cavity volume is increased) it is possible to counter the retraction and obtain shaped abrasive particle that have at least three substantially planar major sides. The degree of concavity generally depends on the solids content of the precursor dispersion.

The liquid vehicle may include water and/or organic solvent. The liquid vehicle includes water in an amount of at least 50, 60, 70, 80, 90, or even at least 9 percent by weight of the liquid vehicle. Any organic solvent in the liquid vehicle is water-soluble, or at least water-miscible. Examples include lower alcohols (e.g., methanol, ethanol, propanol), ethers (e.g., glyme, and diglyme), and lactams (e.g., 2-pyrrolidone).

At least a portion of the slurry is next contacted with a substrate to form shaped bodies. The substrate can be any of the tools described above. After forming the slurry into shaped bodies, the shaped bodies are at least partially dried to provide shaped abrasive precursor particles. This may be accomplished, for example, using an oven, heated platen, heat gun, or infrared heater. As used herein, the term “drying” refers to removal of at least a portion of the liquid vehicle, which may or may not specifically refer to removal of water.

The liquid vehicle can be removed at a fast evaporation rate. In some embodiments, removal of the liquid vehicle by evaporation occurs at temperatures above the boiling point of the liquid vehicle. An upper limit to the drying temperature may depend on the material that the mold is made from. For polypropylene tooling, the temperature should generally be less than the melting point of polypropylene, preferably less than the softening point.

During drying, the slurry shrinks, which may cause retraction from the cavity walls. For example, if the cavities have planar walls, then the resulting tetrahedral shaped abrasive particles may tend to have at least three concave major sides. By making the cavity walls concave (whereby the cavity volume is increased) it is possible to obtain the tetrahedral shaped abrasive particles 16 that have at least three substantially planar major sides. The degree of concavity required generally depends on the solids content of the slurry.

A further operation involves removing resultant precursor shaped abrasive particle 100 from the mold cavities. The precursor shaped abrasive particles can be removed from the cavities by using the following processes alone or in combination on the mold: gravity, vibration, ultrasonic vibration, vacuum, or pressurized air to remove the particles from the mold cavities.

The precursor shaped abrasive particles can be further dried outside of the mold. If the precursor dispersion is dried to the desired level in the mold, this additional drying step is not necessary. However, in some instances it can be economical to employ this additional drying step to minimize the time that the precursor dispersion resides in the mold. The precursor shaped abrasive particle 300 will be dried from 10 to 480 minutes, or from 120 to 400 minutes, at a temperature from 50° C. to 160° C., or 120° C. to 150° C.

A further operation involves calcining the precursor shaped abrasive particles. During calcining, essentially all the volatile material is removed, and the various components that were present in the precursor dispersion are transformed into metal oxides. The precursor shaped abrasive particles are generally heated to a temperature from 400° C. to 800° C. and maintained within this temperature range until the free water and over 90 percent by weight of any bound volatile material are removed. In an optional step, it can be desirable to introduce the modifying additive by an impregnation process. A water-soluble salt can be introduced by impregnation into the pores of the calcined, precursor shaped abrasive particles. Then the precursor shaped abrasive particles are pre-fired again.

A further operation can involve sintering the calcined, precursor shaped abrasive particles to form particles 300. In some examples where the precursor includes rare earth metals, however, sintering may not be necessary. Prior to sintering, the calcined, precursor shaped abrasive particle are not completely densified and thus lack the desired hardness to be used as shaped abrasive particle 300. Sintering takes place by heating the calcined, precursor shaped abrasive particle 300 to a temperature of from 1000° C. to 1650° C. The length of time for which the calcined, precursor shaped abrasive particle can be exposed to the sintering temperature to achieve this level of conversion depends upon various factors, but from five seconds to 48 hours is possible.

In another embodiment, the duration of the sintering step ranges from one minute to 90 minutes. After sintering, the shaped abrasive particle 300 can have a Vickers hardness of 10 GPa (gigaPascals), 16 GPa, 18 GPa, 20 GPa, or greater.

Additional operations can be used to modify the described process, such as, for example, rapidly heating the material from the calcining temperature to the sintering temperature, and centrifuging the precursor dispersion to remove sludge and/or waste. Moreover, the process can be modified by combining two or more of the process steps if desired.

To form soft shaped abrasive particles 300 the polymerizable mixtures described herein can be deposited in a cavity. The cavity can have a shape corresponding to the negative impression of the desired shaped abrasive particles 300. After the cavity is filled to the desired degree, the polymerizable mixture is cured therein. Curing can occur at room temperature (e.g., about 25° C.) or at any temperature above room temperature. Curing can also be accomplished by exposing the polymerizable mixture to a source of electromagnetic radiation or ultraviolet radiation.

Shaped abrasive particles 300 can be independently sized according to an abrasives industry recognized specified nominal grade. Abrasive industry recognized grading standards include those promulgated by ANSI (American National Standards Institute), FEPA (Federation of European Producers of Abrasives), and JIS (Japanese Industrial Standard). ANSI grade designations (i.e., specified nominal grades) include, for example: ANSI 4, ANSI 6, ANSI 8, ANSI 16, ANSI 24, ANSI 36, ANSI 46, ANSI 54, ANSI 60, ANSI 70, ANSI 80, ANSI 90, ANSI 100, ANSI 120, ANSI 150, ANSI 180, ANSI 220, ANSI 240, ANSI 280, ANSI 320, ANSI 360, ANSI 400, and ANSI 600. FEPA grade designations include F4, F5, F6, F7, F8, F10, F12, F14, F16, F18, F20, F22, F24, F30, F36, F40, F46, F54, F60, F70, F80, F90, F100, F120, F150, F180, F220, F230, F240, F280, F320, F360, F400, F500, F600, F800, F1000, F1200, F1500, and F2000. JIS grade designations include 1158, 11512, JI516, JI524, JI536, JI546, JI554, JI560, JI580, JIS100, JIS150, JIS180, JI5220, JI5240, JI5280, JI5320, JI5360, 115400, 115600, 115800, JIS1000, JIS1500, JI52500, JI54000, 1156000, 1158000, and JIS10,000.

Examples of Articles Using Shaped Abrasive Particles with Sharp Edges

FIG. 4 illustrates a method of abrading a workpiece in an embodiment of the present invention. While method 400 illustrates a single shaped abrasive particle 404, it is to be understood that this is by example only, as many abrading operations rely on the combined cutting ability of many shaped abrasive particles. For example, a coated abrasive product may include many shaped abrasive particles 404 embedded on a backing.

Shaped abrasive particle 404 moves in a direction 410 across a surface of workpiece 420. Material removed during the abrading process, also known as swarf 430, gathers in front of a leading edge of shaped abrasive particle 404. In at least some embodiments described herein, shaped abrasive particle 404 has a preferred orientation 420. As illustrated in FIG. 4, in one embodiment, preferred orientation is about 90°. Such an orientation may, for example, ensure that shaped abrasive particle 404 is self-sharpening. Self-sharpening may occur, for example, through fracturing caused by orienting shaped abrasive particle 404 in a stress state.

While shaped abrasive particles have been discussed thus far in the context of a flat-surfaced tool, it is also to be understood that, in some embodiments, a tool has surface features. The surface features may impart additional structure to a shaped abrasive particle. FIG. 5, discussed below, illustrates one example embodiment of a tool with a three-dimensional structure.

FIG. 5 illustrates an example tool for making three dimensional shaped abrasive particles with sharp edges in an embodiment of the present invention. Method 500 can be used to create a shaped abrasive particle 550 with three-dimensional structure. Tool 502 has a cavity 504 and surface factures 506. Surface features 506 form a top surface profile of a resulting shaped abrasive particle 550. Once cavity 504 is filled with a shaped abrasive particle precursor material 508, as illustrated in step 510, a scraper 530 is used to level the precursor material with the surface of tool 502. Scraper 530 moves, in one embodiment, in direction 532. Once precursor material 508 undergoes a preliminary drying step, it can be removed, as indicated by step 520, resulting in a shaped abrasive particle 550. In some embodiments, shaped abrasive particle undergoes additional processing steps as described below.

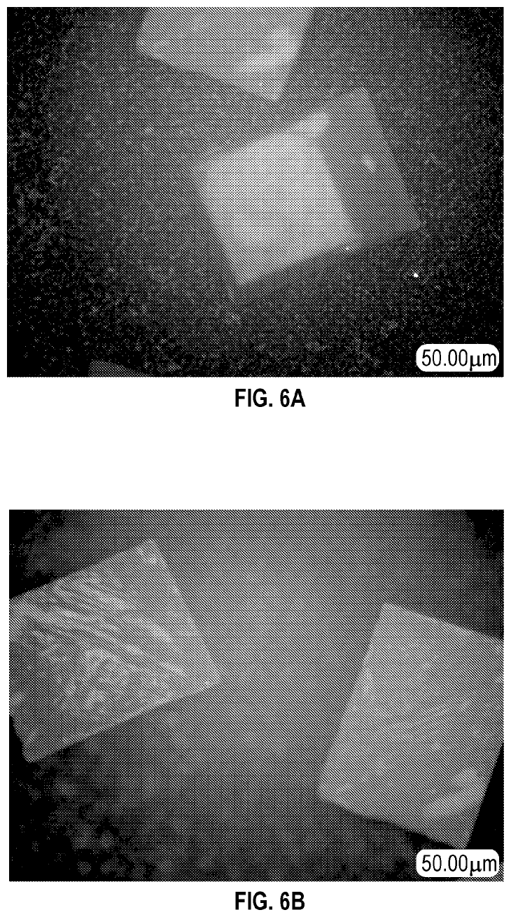

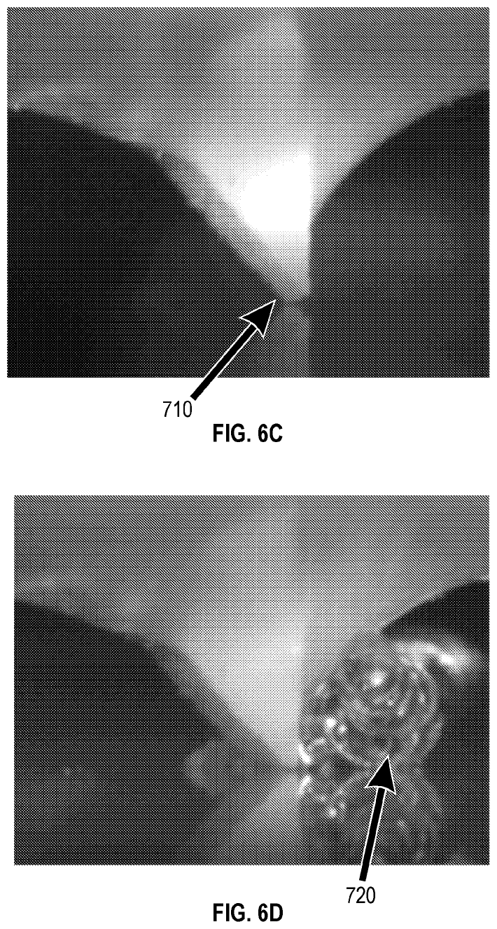

FIGS. 6A and 6B show example shaped abrasive particles with sharp edges in accordance with embodiments of the present invention.

FIGS. 6C and 6D show an example shaped abrasive particle with a sharp edge abrading a workpiece in accordance with an embodiment of the present invention. The FIGS. 6C and 6D are the side views of the shaped abrasive particles viewed in the direction perpendicular to the direction 410 illustrated in FIG. 4. As illustrated, shaped abrasive particle 610 has a sharp edge. When in contact with a workpiece, the sharp edge removes a significant portion of material 620 from the surface of a workpiece. Illustrated in FIGS. 6C and 6D is a trapezoidal shaped abrasive particle 610, in a 90° cutting orientation with respect to an AISI 1045 steel workpiece.

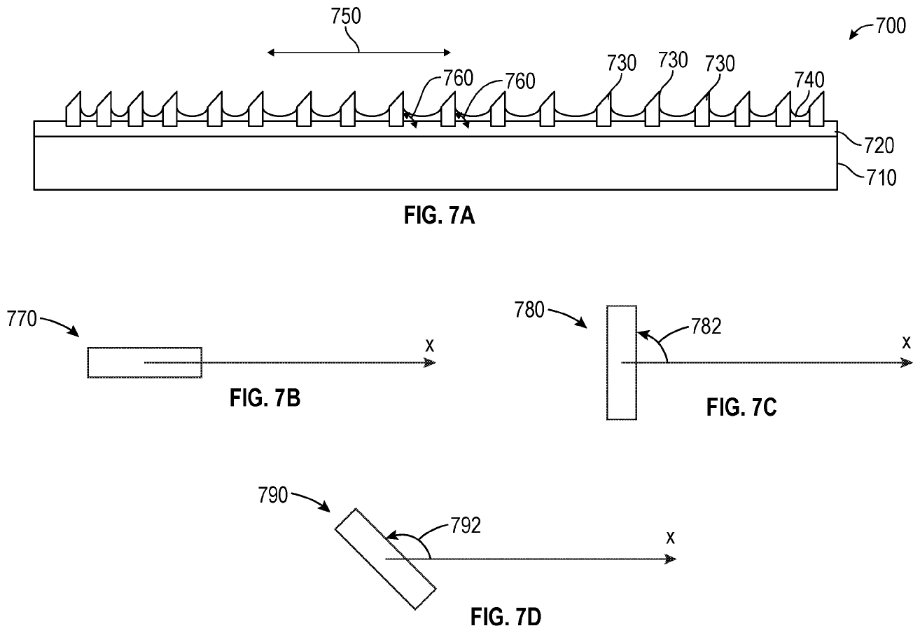

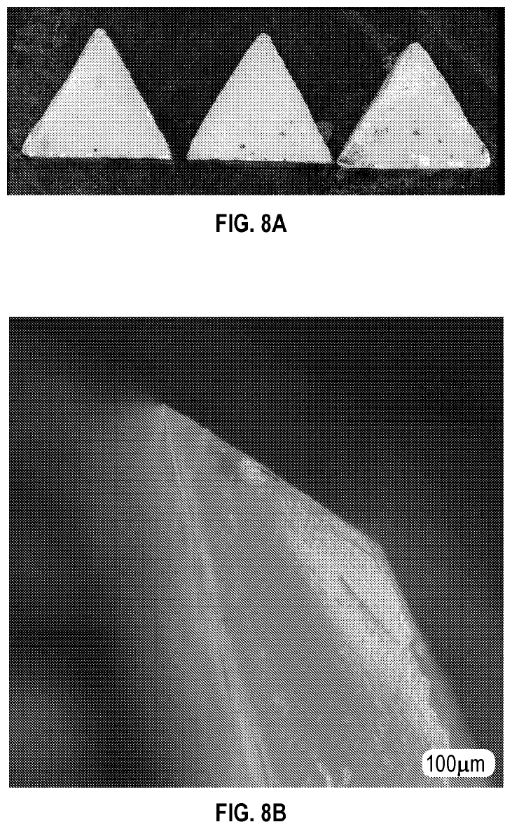

FIG. 7 illustrates a sectional view of a coated abrasive article in accordance with an embodiment of the present invention. Coated abrasive article 700 may be used in an abrading operation of a workpiece. In some embodiments, coated abrasive article 700 is configured for use in a certain direction, based on orientation of shaped abrasive particles 730. For example, as illustrated in FIG. 7, coated abrasive article is configured to move in direction 750 along a workpiece for maximum material removal. However, moving abrasive article 700 in another direction may also be useful, depending on the abrading operation being conducted, for example as part of a finishing operation.

Coated abrasive article 700 includes a backing 710. The backing has a first layer of binder, referred to as make coat 720. Attached or partially embedded in make coat 720 are a plurality of shaped abrasive particles 730. Shaped abrasive particles 730 include a sharp edge, and may be made in accordance with methods described herein. A second layer of binder, referred to a size coat 740, may be dispersed over shaped abrasive particles 730. Make coat 720 secures shaped abrasive particles 730 to backing 710 and size coat 740 helps to reinforce shaped abrasive particles 830. Make coat 720 and/or size coat 740 may include a resinous adhesive. The resinous adhesive may include one or more resins chosen from a phenolic resin, an epoxy resin, a urea-formaldehyde resin, an acrylate resin, an aminoplast resin, a melamine resin, an acrylated epoxy resin, a urethane resin, and mixtures thereof.

Abrasive article can be chosen from many different abrasive articles such as an abrasive belt, an abrasive sheet or an abrasive disc. Abrasive article 700 includes a backing 710, which can have any desirable degree of flexibility. Backing 710 can include any suitable material. For example, backing 710 can include a polymeric film, a metal foil, a woven fabric, a knitted fabric, paper, a vulcanized fiber, a nonwoven, a foam, a screen, a laminate, or combinations thereof. Backing 710 can further include various additive(s). Examples of suitable additives include colorants, processing aids, reinforcing fibers, heat stabilizers, UV stabilizers, and antioxidants. Examples of useful fillers include clays, calcium carbonate, glass beads, talc, clays, mica, wood flour; and carbon black.

Shaped abrasive particles 730 can be positioned relative to backing 710 to achieve several performance characteristics of abrasive article 700. The positioning of shaped abrasive particles 730 can be characterized by a variety of different angles relative to backing 710.

For example, angle 760 can be characterized by an angle measured between backing 710 and a leading face of shaped abrasive particle 730. As shown in FIG. 7, angle 760 is about 90 degrees. However, in other embodiments, angle 760 can be chosen from a value in a range of from about 10 degrees to about 170 degrees, about 80 degrees to about 100 degrees, about 85 degrees to about 95 degrees, or less than, equal to, or greater than about 10 degrees, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, or about 170 degrees. The value of angle 760 can be selected for the intended purpose of abrasive article 700. For example, if angle 760 is equal to or less than 90 degrees, abrasive article 700 may be well suited to remove material from a workpiece, achieve a deep cut in the workpiece, or remove a large piece of swarf from the workpiece. According to some embodiments, these angle values can be useful for abrading “softer” materials such as aluminum or wood. Conversely, if angle 760 is greater than 90 degrees, abrasive article 700 may still have some of the characteristics previously described, but may additionally be better suited for finishing a surface of the workpiece. According to some embodiments, these rake angle values can be useful for abrading “harder” materials such as steel or Inconel.

In some embodiments, it may be desirable for a certain percentage of shaped abrasive particles 730 to have substantially the same angle 760. For example, in some embodiments, an angle 760 of about 50% to about 100% of the shaped abrasive particles is substantially the same, or about 90% to about 100%, or less than, equal to, or greater than about 50%, 55, 60, 65, 70, 75, 80, 85, 90, 95, or 100%. Having 100% of abrasive particles 730 of abrasive article 700 sharing the same rake angle 760 can be desirable in achieving consistent performance of abrasive article 700. However, in some embodiments, it may be desirable to have different rake angles 760. For example, some embodiments of abrasive article 700 may include a plurality of rows abrasive particles 730. The rows may extend in the y-direction and adjacent rows can be spaced relative to each other in the x-direction. The spacing between adjacent shaped abrasive particles in both the x-direction and y-direction can be consistent or random. In embodiments including multiple rows, it is possible for each abrasive particle 730 in a row to have the same rake angle 760. For example, there may be a gradient of rake angles extending from one portion of abrasive article 700 to another portion.

FIGS. 7B-7D illustrate top views of different particles illustrating some orientations that are possible within the X-Y plane. For example, FIG. 7B illustrates a particle 770 with an orientation angle of 0°. FIG. 7C illustrates a particle 780 with an orientation angle 782. Orientation angle 782 is about 90°. FIG. 7D illustrates a particle 790 with an orientation angle 792. Orientation angle 792 is an obtuse angle, measuring about 135°.

While FIG. 7A illustrates abrasive particles positioned at a substantially right-angle with respect to the backing, other inclinations are also envisioned. For example, as described in co-pending U.S. Provisional Patent Application No. 62/754,225, filed Nov. 1, 2018, controlling a rake angle, or an inclination of the particles, can greatly affect the abrasive performance of an abrasive particle and, therefore, an abrasive article.

A rake angle can be characterized by an angle measured between backing and leading surface or cutting tip. A rake angle for particles on a coated abrasive article can be chosen from a value in a range of from about 10 degrees to about 170 degrees, about 80 degrees to about 100 degrees, about 85 degrees to about 95 degrees, or less than, equal to, or greater than about 10 degrees, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, or about 170 degrees. The value of rake angle can be selected for the intended purpose of an abrasive article, such as an abrasive belt, for example. For example, if a rake angle is equal to or less than 90 degrees, the abrasive article may be well suited to remove material from a workpiece, achieve a deep cut in the workpiece, or remove a large piece of swarf from the workpiece. Conversely, if the rake angle is greater than 90 degrees, an abrasive belt may still have some of the characteristics previously described, but may additionally be better suited for finishing a surface of the workpiece. Additional discussion on rake angles of abrasive particles can be found in U.S. Provisional Patent Application No. 62/661,801, filed Apr. 24, 2018, which is herein incorporated by reference.

Various methods can be used to make abrasive articles according to the present disclosure. For example, coated abrasive article 700, can be formed by applying make coat 720 on backing 710. Make coat 720 can be applied by any suitable technique such as roll coating. Abrasive particles 730 can then be deposited on make coat 720. Alternatively, abrasive particles 730 and the formulation for make coat 720 can be mixed to form a slurry, which is then applied to backing 710. If coated abrasive article 700 includes shaped abrasive particles 730, crushed abrasive particles, and secondary formed abrasive particles, those particles can be applied as discrete groups sorted by particle type or together. Once the abrasive particles are deposited on backing 710, make coat 720 is cured at an elevated temperature or at room temperature for a set amount of time and the abrasive particles adhere to the backing 710. A size coat 740 can then be optionally applied over the coated abrasive article 700. Optionally, an additional top coat (not shown) can also be applied over size coat 740.

The make coat, size coat, or both can include any suitable resin such as a phenolic resin, an epoxy resin, a urea-formaldehyde resin, an acrylate resin, an aminoplast resin, a melamine resin, an acrylated epoxy resin, a urethane resin, or mixtures thereof. Additionally, the make coat, size coat, or both can include a filler, a grinding aid, a wetting agent, a surfactant, a dye, a pigment, a coupling agent, an adhesion promoter, or a mixture thereof. Examples of fillers may include calcium carbonate, silica, talc, clay, calcium metasilicate, dolomite, aluminum sulfate, or a mixture thereof.

In coated abrasive article 700, the shaped abrasive particles 730 can range from about 1 wt % to about 90 wt % of the abrasive layer, or about 10 wt % to about 50 wt % of the abrasive article, or can be less than, equal to, or greater than about 1 wt %, 5, 10, 15, 20, 25, 30, 35, 40, 45, 50, 55, 60, 65, 70, 75, 80, 85, or 90 wt %.

Shaped abrasive particles 730 can be deposited on backing 710 through any suitable technique. For example, shaped abrasive particles 730 can be deposited through a drop-coating technique or an electrostatic-coating technique onto backing 710. In drop-coating, abrasive particles 730 are free-form deposited on a make coat 720. In an example of an electrostatic-coating technique, an electrostatically charged vibratory feeder can be used to propel abrasive particles 730 off of a feeding surface towards a conductive member located behind backing 710. In some embodiments, the feeding surface can be substantially horizontal and the coated backing can be traveling substantially vertically. Abrasive particles 730 pick up a charge from the feeder and are drawn towards the backing by the conductive member.

FIG. 7 illustrates an embodiment in which abrasive article 700 is an abrasive belt or an abrasive sheet adapted for linear movement. In other embodiments, however, the abrasive article can be an abrasive disc that is adapted for rotational movement. In some embodiments, shaped abrasive particles 730 can be included in a random orbital sander or vibratory sander. In these embodiments, it may be desirable to have shaped abrasive particles 730 be randomly oriented. This is because the direction of use of such an abrasive article is variable.

Shaped abrasive particles 730 can account for 100 wt % of the abrasive particles in any abrasive article. Alternatively, shaped abrasive particles 730 can be part of a blend of abrasive particles distributed on backing 710. If present as part of a blend, shaped abrasive particles 100 may be in a range of from about 5 wt % to about 95 wt % of the blend, about 10 wt % to about 80 wt %, about 30 wt % to about 50 wt %, or less than, equal to, or greater than about, 5 wt %, 10, 15, 20, 25, 30, 35, 40, 45, 50, 55, 60, 65, 70, 75, 80, 85, 90, or about 95 wt %, of the blend. In the blend, the balance of the abrasive particles may include conventional crushed abrasive particles. Crushed abrasive particles are generally formed through a mechanical crushing operation and have no replicated shape. The balance of the abrasive particles can also include other shaped abrasive particles, that may for example, include an equilateral triangular shape (e.g., a flat triangular shaped abrasive particle or a tetrahedral shaped abrasive particle in which each major face of the tetrahedron is an equilateral triangle).

The abrasive articles described herein can be manufactured according to any suitable method. Generally stated, the abrasive articles can be formed by orienting at least a portion of shaped abrasive particles 730 on backing 710 at a desired angle 760. The method can further include adhering shaped abrasive particles 730 to backing 710.

Orienting shaped abrasive particles 730 can be accomplished, for example, by including one or more cavities in backing 710. The cavities can be shaped in such a manner that individual shaped abrasive particles 730 are positioned on backing 710 such that the particles fit in the cavities in a desired orientation.

Including cavities in backing 710 can allow for shaped abrasive particles 730 to be drop coated or electrostatically coated to backing 710 while achieving the intended orientation. As generally understood, in a drop coating technique, a bulk supply of shaped abrasive particles 730 are fed through a hopper and fall onto backing 710 under the force of gravity and land in the cavities. Without the cavities, a spatial orientation of shaped abrasive particles 730 upon contacting the backing 710 would be entirely random in all directions. However, the cavities take away the random spatial orientations.

In other embodiments, precise orientation of shaped abrasive particles 730 can be accomplished using a distribution tool or a screen. The distribution tool or screen can include one or more slots defined by a plurality of walls. The slots can be open on two ends. One end can be configured to receive shaped abrasive particle 730 and the other end can be in contact with backing 710. Backing 204 can optionally have a make coat distributed thereon. The slots are designed such that individual shaped abrasive particles 730 are positioned on backing 710 such that angle 760 achieves a predetermined value. Particles that do not properly enter the cavities can be swept from the distribution tool and additional particles can be contacted with the distribution tool to enter the vacant slots.

The distribution tool including shaped abrasive particles 730 can be left in contact with backing 710 for any suitable amount of time as shaped abrasive particles 730 adhere to make coat 720. After sufficient time has passed for good adhesion between shaped abrasive particles 100 and the make coat, the production tool is removed and a size coat is optionally disposed over shaped abrasive particles 730.

In other embodiments, precise orientation of shaped abrasive particles 730 can be achieved using a rotating production tool. The rotating production tool is circular and includes a plurality of cavities on an external surface. Each of the cavities are designed to receive shaped abrasive particles 730 in a particular orientation. In order to increase the probability that each cavity is filled, an excess of shaped abrasive particles 730 is contacted with production tool. Shaped abrasive particles 730 that do not enter the cavities are collected for later use. Once secured in the cavities, shaped abrasive particles 730 are contacted with backing 710, which can be supplied as a web. Backing 710 can have make coat pre-disposed thereon so that upon contact, shaped abrasive particles 730 adhere to backing 710 and are removed from the production tool.

In other embodiments, precise orientation of shaped abrasive particles 100 can be achieved using shaped abrasive particles that include at least some magnetic material. The shaped abrasive particles including at the magnetic material can be arranged randomly on backing 710. Shaped abrasive particles 730 can then be exposed to a magnetic field in such a manner that shaped abrasive particles 730 are rotated into a desired orientation. Other methods of orienting the particles may also be possible. For example, particles 730 could pass through a magnetic field while being deposited onto backing 710. Once properly oriented, shaped abrasive particles 730 can be adhered to backing 710 with the make coat and optionally the size coat. As a result of this process, individual shaped abrasive particles 730 are positioned on backing 710 such that angle 710 achieves a predetermined value.

Once the magnetizable particles are coated on to the curable binder precursor it is at least partially cured at a first curing station (not shown), so as to firmly retain the magnetizable particles in position. In some embodiments, additional magnetizable and/or non-magnetizable particles (e.g., filler abrasive particle and/or grinding aid particles) can be applied to the make layer precursor prior to curing.

In the case of a coated abrasive article, the curable binder precursor comprises a make layer precursor, and the magnetizable particles comprise magnetizable abrasive particles. A size layer precursor may be applied over the at least partially cured make layer precursor and the magnetizable abrasive particles, although this is not a requirement. If present, the size layer precursor is then at least partially cured at a second curing station, optionally with further curing of the at least partially cured make layer precursor. In some embodiments, a supersize layer is disposed on the at least partially cured size layer precursor.

According to various embodiments, a method of using an abrasive article such as abrasive article 700 contacting shaped abrasive particles 730 with a workpiece or substrate. The workpiece or substrate can include many different materials such as steel, steel alloy, aluminum, plastic, wood, or a combination thereof. Upon contact, one of the abrasive article and the workpiece is moved relative to one another in direction of use and a portion of the workpiece is removed.

According to various embodiments, a cutting depth into the substrate or workpiece can be at least about 2 μm, at least about 10 μm, at least about 20 μm, at least about 30 μm, at least about 40 μm, at least about 50 μm, or at least about 60 μm, or at least 500 μm. A portion of the substrate or workpiece is removed by the abrasive article as a swarf.

According to various embodiments, a cutting speed of the abrasive article can be at least about 100 m/min, at least about 110 m/min, at least about 120 m/min, at least about 130 m/min, at least about 140 m/min, at least about 150 m/min, at least about 160 m/min at least about 170 m/min, at least about 180 m/min, at least about 190 m/min, at least about 200 m/min, at least about 300 m/min, at least about 400 m/min, at least about 500 m/min, at least about 1000 m/min, at least about 1500 m/min, at least about 2000 m/min, at least about 2500 m/min, at least about 3000 m/min, or at least about 4000 m/min.

Direction of use 750 is a first direction indicated in FIG. 7. However, it is possible for the abrasive article to be moved in a second direction that is different than direction of use 750. The two directions may result in differing removal rates, and may be suitable for different abrading operations. The second direction can be in a direction rotated about 1 degree to 360 degrees relative to direction of use 202 or 304, about 160 degrees to about 200 degrees, less than, equal to, or greater than about 1 degree, 5, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 230, 240, 250, 260, 265, 270, 275, 280, 285, 290, 295, 300, 305, 310, 315, 320, 325, 330, 335, 340, 350, 355, or about 360 degrees.

Using an Abrasive Article with Shaped Abrasive Articles with Sharp Edges

The present disclosure also relates to methods for abrading a workpiece, the method comprising frictionally contacting at least a portion of an abrasive article according to the invention with a surface of a workplace; and moving at least one of the workpiece or the abrasive article (while in contact) to abrade at least a portion of the surface of the workpiece.

During use, the bonded abrasive article can be used dry or wet. During wet grinding, the bonded abrasive article is typically used in conjunction with a grinding fluid which may for example contain water or commercially available lubricants (also referred to as coolants). During wet grinding lubricants are commonly used to cool the workpiece and wheel, lubricate the interface, remove swarf (chips), and clean the wheel. The lubricant is typically applied directly to the grinding area to ensure that the fluid is not carried away by the grinding wheel. The type of lubrication used depends on the workpiece material and can be selected as is known in the art.

Common lubricants can be classified based on their ability to mix with water. A first class suitable for use in the present invention includes oils, such as mineral oils (typically petroleum based oils) and plant oils. A second class suitably for use in the present invention includes emulsions of lubricants (for example mineral oil based lubricants; plant oil based lubricants and semi-synthetic lubricants) and solutions of lubricants (typically semi-synthetic and synthetic lubricants) with, water.

According to various embodiments, the abrasive articles described herein can have several advantages when moved in direction of use as opposed to any other direction of use. For example, at the same applied force, cutting speed, or a combination thereof, an amount of material removed from the workpiece, length of a swarf removed from the workpiece, depth of cut in the workpiece, surface roughness of the workpiece or a combination thereof is greater in the first direction than in any other second direction.

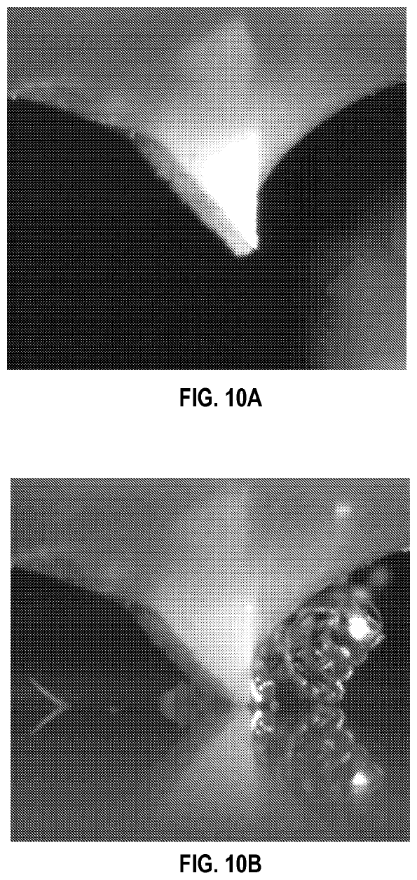

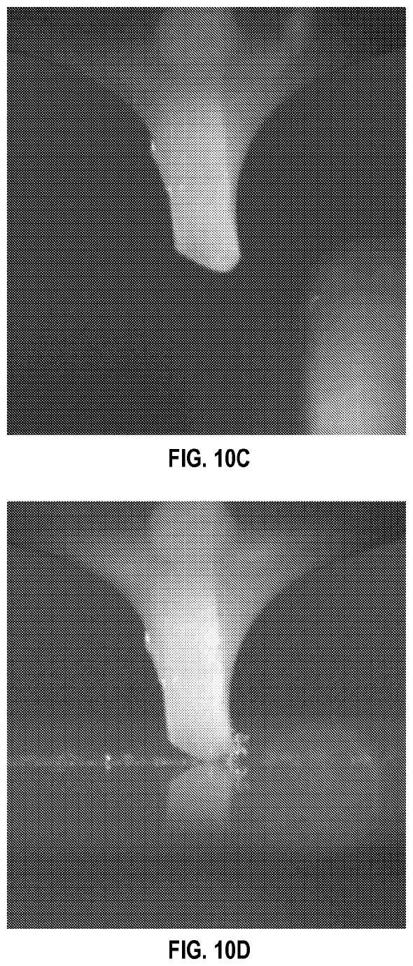

FIGS. 10A and 10B illustrate differences in sharpness between prior art shaped particles and particles made in accordance with embodiments of the present invention.

Shaped abrasive particles made using the methods described herein may, in some embodiments, provide improved abrading efficiency when compared to traditional shaped abrasive particles and/or conventional crushed abrasive particles. The sharp edge of shaped abrasive particles described in at least some embodiments herein can have a radius of curvature two or more times less (i.e. sharper) than particles made by previously disclosed methods of making shaped abrasive particles. For example, the radius of curvature may be as low as 7 μm as compared with previous methods which yielded radii of curvature 14 μm or higher.

The methods described herein do not require high precision corners or other features within a mold cavity. This may reduce the cost to make manufacturing tools, while resulting in shaped abrasive particles with improved cutting effectiveness.

Additionally, shaped abrasive particles with sharp edges may have a longer use life than their traditional counterparts. Sharp edged shaped abrasive particles are durable, and have a higher cut rate than conventional shaped abrasive particles.

### EXAMPLES

Various embodiments of the present disclosure can be better understood by reference to the following Examples which are offered by way of illustration. The present disclosure is not limited to the Examples given herein

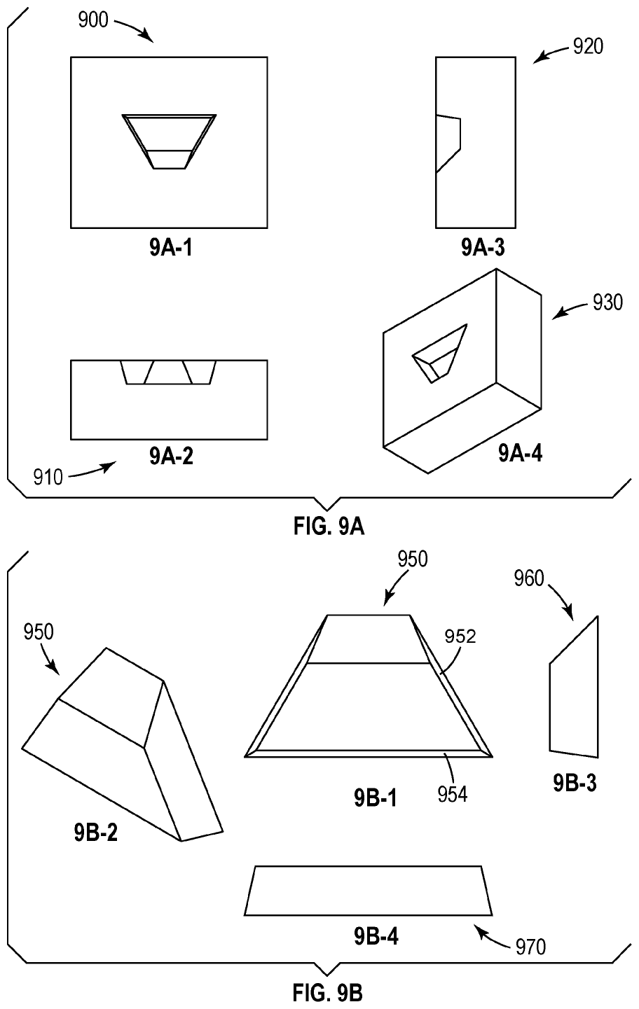

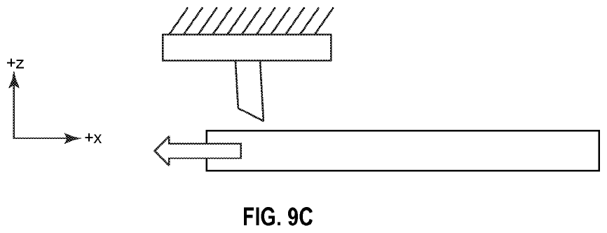

TABLE 1

| ABBREVIATION | DESCRIPTION |
|---|---|
| AP1 | Shaped abrasive particles were prepared |
| | according to the disclosure of U.S. Patent |
| | 8,142,531. The shaped abrasive particles |
| | were prepared by molding alumina sol gel |
| | in polypropylene mold cavities with |
| | dimensions shown in FIG. 9A, after drying |
| | and firing, the resulting shaped abrasive |
| | particles had dimensions shown in FIG. 9B. |
| AP2 | Shaped abrasive particles were prepared |
| | according to the disclosure of U. S. Pat. |
| | No. 8,142,531 (Adefris et al). The shaped |
| | abrasive particles were prepared by molding |
| | alumina sol gel in equilateral triangle-shaped |
| | polypropylene mold cavities. After drying |
| | and firing, the resulting shaped abrasive |
| | particles were about 1.4 mm (side |
| | length) × 0.35 mm (thickness), with |
| | a draft angle approximately 98 degrees. |

### Example 1: Testing of Abrasive Particles

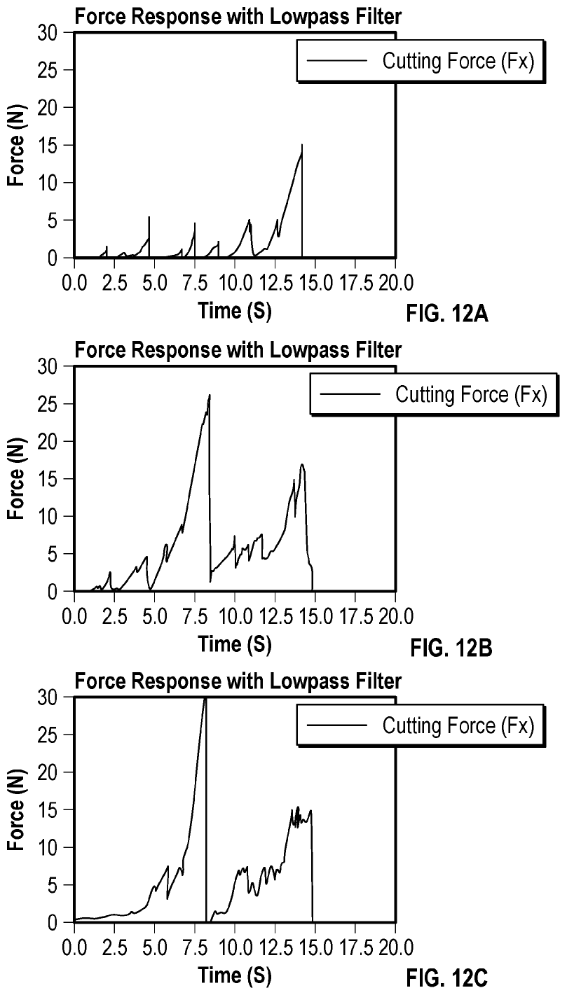

In this example, a smooth, flat, plate of steel AISI 1018, described as the workpiece, was brought into contact with a single shaped abrasive particle AP1. The single shaped abrasive particle was secured on a stainless-steel plate with 3M Scotch-Weld Epoxy Adhesive DP460 (available from 3M Company, St. Paul, Minn.). The stainless-steel plate was secured to a larger, stationary frame with screws. While the single shaped abrasive particle was held stationary, the workpiece was translated in space in the negative x-direction (as shown in FIG. 9C) via a linear actuator (Zaber Technologies Inc., Vancouver, British Columbia, Canada, model #: A-LST0250B-E01C) using displacement control at a speed of 5 mm/second. FIG. 10A depicts this procedure. FIG. 12 is a side view of the shaped abrasive particle viewed in the direction 410 illustrated in FIG. 4.

Contact between the shaped abrasive particle and the steel 1018 workpiece was observed using a camera (Vision Research, model: Phantom VEO 640S Digital High-Speed Camera, Wayne N.J.) recording at 300 frames/second. FIG. 10A shows the abrasive particle AP1 immediately before contact between the particle and the workpiece began. FIG. 10B shows abrasive particle AP1 during the test. The image shows the particle abrading the workpiece surface, and a material chip, or swarf, which the particle is removing from the workpiece due to cutting action, is evident. FIGS. 10C and 10D show images analogous to FIGS. 10A and 10B for particle AP2. FIG. 12C displays the abrasive particle AP2 immediately before contact between the particle and the workpiece began in a separate experiment from that displayed in FIG. 10B. FIG. 10D shows abrasive particle AP2 during the test. The image shows the particle abrading the workpiece surface, and a material chip, or swarf, which the particle is removing from the workpiece due to cutting action, is evident.

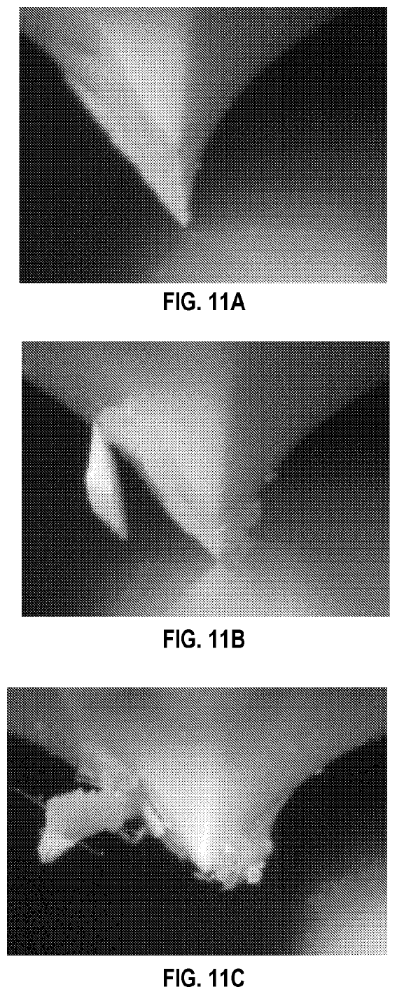

FIGS. 11A-11C illustrate the progressive fracturing of a shaped abrasive particle AP1 during different passes. The force response corresponding to each pass is illustrated in FIGS. 12A-12C.

### Additional Embodiments

The following exemplary embodiments are provided, the numbering of which is not to be construed as designating levels of importance:

A shaped abrasive particle with a first face and a second face is presented. the first face and the second face being separated by a thickness. The second face has a different shape than the first face. The shaped abrasive particle also includes a sharp portion defined by an interface between a third face and the first face. The third face extends from the second face to the first face, wherein the second face is polygonal in shape.

The shaped abrasive particle may be implemented such that the sharp portion forms an edge of the first face.

The shaped abrasive particle may be implemented such that the features of Embodiment 2, however the edge is a straight edge.

The shaped abrasive particle may be implemented such that the edge is a curved edge.

The shaped abrasive particle may be implemented such that the edge is concave, or curved.

The shaped abrasive particle may be implemented such that the edge is convex.

The shaped abrasive particle may be implemented such that the angle between the third face and the second face is at least 135° within the sharp portion.

The shaped abrasive particle may be implemented such that the angle between the third face and the first face is less than 80°.

The shaped abrasive particle may be implemented such that the third face is curved.

The shaped abrasive particle may be implemented such that the sharp portion has a radius of curvature less than 20 μm.

The shaped abrasive particle may be implemented such that the sharp portion has a radius of curvature less than 15 μm.

The shaped abrasive particle may be implemented such that the sharp portion has a radius of curvature less than 10 μm.

The shaped abrasive particle may be implemented such that the sharp portion comprises an edge of the first face, and wherein the edge has a radius of curvature less than 10 μm.

The shaped abrasive particle may be implemented such that the sharp portion comprises a sharp point.

The shaped abrasive particle may be implemented such that the sharp portion is a first sharp portion, and wherein the shaped abrasive particle comprises a second sharp portion.

The shaped abrasive particle may be implemented such that the sharp portion causes the shaped abrasive particle to have a first abrading efficiency when applied in a first direction, and a second abrading efficiency when applied in a second direction.

The shaped abrasive particle may be implemented such that the shaped abrasive particle is a self-orienting particle such that, when dropped on a substrate, the sharp portion points away from the substrate.

The shaped abrasive particle may be implemented such that the abrasive particle comprises a ceramic or polymeric material.

The shaped abrasive particle may be implemented such that the abrasive particle comprises alpha alumina or sol-gel derived alpha alumina.

The shaped abrasive particle may be implemented such that the abrasive particle comprises fused aluminum oxide, heat-treated aluminum oxide, ceramic aluminum oxide, sintered aluminum oxide, a silicon carbide material, titanium diboride, boron carbide, tungsten carbide, titanium carbide, cubic boron nitride, garnet, fused alumina-zirconia, cerium oxide, zirconium oxide, or titanium oxide.

The shaped abrasive particle may be implemented such that the abrasive particle comprises a polymerizable material with a resin.

The shaped abrasive particle may be implemented such that the resin is a phenolic resin, a urea formaldehyde resin, a urethane resin, a melamine resin, an epoxy resin, a bismaleimide resin, a vinyl ether resin, an aminoplast resin (which may include pendant alpha, beta unsaturated carbonyl groups), an acrylate resin, an acrylated isocyanurate resin, an isocyanurate resin, an acrylated urethane resin, an acrylated epoxy resin, an alkyl resin, a polyester resin, or a drying oil.

The shaped abrasive particle may be implemented such that the abrasive particle comprises plasticizer, an acid catalyst, a cross-linker, a surfactant, a mild-abrasive, a pigment, a catalyst or an antibacterial agent.

The shaped abrasive particle may be implemented such that the shaped abrasive particle comprises at least one triangle-shaped surface, wherein the triangle-shaped surface comprises the sharp portion and wherein the sharp portion is either a sharp corner or a sharp edge.

The shaped abrasive particle may be implemented such that the shaped abrasive particle comprises at least one quadrilateral-shaped surface, wherein the quadrilateral-shaped surface comprises the sharp portion, and wherein the sharp portion is a sharp edge.

The shaped abrasive particle may be implemented such that the first face has a different area than the second face.

The shaped abrasive particle may be implemented such that the second face has a smaller area than the first face.

The shaped abrasive particle may be implemented such that the shaped abrasive particle comprises at least one shape feature comprising: an opening, a concave surface, a convex surface, a groove, a ridge, a fractured surface, a sloping sidewall, a cavity, a low roundness factor, or a perimeter comprising one or more corner points having a sharp tip.

The shaped abrasive particle may be implemented such that the shaped abrasive particle is responsive to a magnetic field.

The shaped abrasive particle may be implemented such that the shaped abrasive particle comprises a magnetic material.

The shaped abrasive particle may be implemented such that the magnetic material at least partially coats the shaped abrasive particle.

The shaped abrasive particle may be implemented such that an angle formed at the intersection between the first face and the third face is an acute angle.

The shaped abrasive particle may be implemented such that an angle formed at the intersection between the first face and the third face is obtuse.

A shaped abrasive particle is presented. The shaped abrasive particle has a first face and a feature, the first face and the feature separated by a thickness. The shaped abrasive particle also has a sharp portion defined by an interface between a third face and the first face. The third face extends from the feature to the first face. The sharp portion has a radius of curvature of less than 10 μm. The longest dimension of the particle is greater than 500 μm.

The shaped abrasive particle may be implemented such that the feature is a vertex.

The shaped abrasive particle may be implemented such that the feature is a second face.

The shaped abrasive particle may be implemented such that the angle between the first face and the third face is less than 80°.

The shaped abrasive particle may be implemented such that the angle between the second face and the third face is at least 135°.

The shaped abrasive particle may be implemented such that the radius of curvature is less than 10 μm.

The shaped abrasive particle may be implemented such that the sharp portion comprises a sharp point.

The shaped abrasive particle may be implemented such that the sharp portion comprises a sharp edge.

The shaped abrasive particle may be implemented such that the sharp edge has either a concave or convex curve.

The shaped abrasive particle may be implemented such that the sharp portion is a first sharp portion, and wherein the shaped abrasive particle comprises a second sharp portion.

The shaped abrasive particle may be implemented such that the third face is curved.

The shaped abrasive particle may be implemented such that the shaped abrasive particle is a self-orienting particle such that, when dropped on a substrate, the sharp portion points away from the substrate.

The shaped abrasive particle may be implemented such that the shaped abrasive particle comprises at least one triangle-shaped surface, wherein the triangle-shaped surface comprises the sharp portion and wherein the sharp portion is either a sharp corner or a sharp edge.

The shaped abrasive particle may be implemented such that the shaped abrasive particle comprises at least one quadrilateral-shaped surface, wherein the quadrilateral-shaped surface comprises the sharp portion, and wherein the sharp portion is a sharp edge.

The shaped abrasive particle may be implemented such that the shaped abrasive particle comprises at least one shape feature comprising: an opening, a concave surface, a convex surface, a groove, a ridge, a fractured surface, a sloping sidewall, a cavity, or a perimeter comprising one or more corner points having a sharp tip.

The shaped abrasive particle may be implemented such that the shaped abrasive particle is responsive to a magnetic field.

The shaped abrasive particle may be implemented such that the shaped abrasive particle comprises a magnetic material.

The shaped abrasive particle may be implemented such that the magnetic material at least partially coats the shaped abrasive particle.

The shaped abrasive particle may be implemented such that the first face is a polygon with a first number of sides and a first surface area, and wherein the second face is a polygon with a second number of sides and a second surface area.

The shaped abrasive particle may be implemented such that the first number of sides is different from the second number of sides.

The shaped abrasive particle may be implemented such that the second surface area is different from the first surface area.

A method of manufacturing a shaped abrasive particle is presented. The method includes filling a cavity of a tool with an abrasive particle precursor material. The cavity has at least an interior surface that extends downward from a tool top surface at an angle. The method also includes leveling the abrasive particle precursor material such that a top surface of the abrasive particle precursor materials is flush with the tool surface, and such that a sharp portion is formed along the intersection between the sloped wall of the tool cavity and the tool surface and the sharp portion is within the same plane as the tool surface. The method also includes removing a dried abrasive particle precursor from the cavity of the tool. The abrasive particle has a sharp portion formed along the intersection between the interior surface and the tool surface.

The method may be implemented such that the sharp portion comprises a sharp point.

The method may be implemented such that the sharp portion comprises a sharp edge.

The method may be implemented such that the sharp edge is a straight sharp edge.

The method may be implemented such that the sharp edge is a concave sharp edge.

The method may be implemented such that the sharp edge is a convex sharp edge.

The method may be implemented such that the sharp portion is created by the leveling step, such that the sharp portion is within the same plane as the tool surface, and wherein the sharp portion is an intersection between a first face corresponding to the opening of the tool cavity and a second face corresponding to an internal wall of the cavity.

The method may be implemented such that the interior surface is a first interior surface, and wherein the cavity also comprises a second interior surface.

The method may be implemented such that the surface of the tool is non-planar.

The method may be implemented such that the first face is a first polygonal shape and the second face a second polygonal shape, wherein the second polygonal shape is different from the first polygonal shape.

The method may be implemented such that levelling comprises a leveling tool, wherein the non-planar surface of the tool has a surface feature, and wherein the leveling tool is shaped such that it mates with the surface feature.

The method may be implemented such that the second face comprises a smaller area than the first face.

The method may be implemented such that a radius of curvature of the sharp portion is less than 10 μm.

The method may be implemented such that the cavity comprises a negative image of a structure such that the dried particle is a structure. The structure is a polygonal structure or composite of polygonal structures.

The method may be implemented such that the polygonal structure comprises at least one quadrilateral shaped face, and wherein the quadrilateral shaped face comprises the sharp portion.

The method may be implemented such that the sharp portion is either a sharp edge or a sharp point.

The method may be implemented such that the polygonal structure comprises at least one triangle shaped face, and wherein the triangle shaped face comprises the sharp portion.

The method may be implemented such that the sharp portion is either a sharp edge or a sharp point.

The method may be implemented such that the method further comprises calcining the abrasive particle precursor.

The method may be implemented such that the method further comprises sintering the calcined abrasive particle precursor.

The method may be implemented such that the first face and the second face are not parallel.

The method may be implemented such that the internal wall is the downward sloping internal surface.

The method may be implemented such that the first face and the second face are substantially parallel and separated by a thickness.

The method may be implemented such that filling comprises overfilling and wherein leveling comprises removing an excess of the abrasive precursor material.

The method may be implemented such that the leveling step comprises applying a leveling tool to the surface of the tool structure.

The method may be implemented such that the leveling tool comprises a feature configured to mate with a non-planar surface of the tool.

An abrasive article is presented. The abrasive article includes a backing and a plurality of shaped abrasive particles coupled to the backing. At least a portion of the plurality of shaped abrasive particles comprises a first face and a second face. The first face and the second face are coupled by a third face. The interface between the beveled face and the first face is a sharp portion.

The abrasive article may be implemented such that the sharp portion is a sharp edge.

The abrasive article may be implemented such that the sharp edge comprises a straight edge, a concave edge or a convex edge, or a curved edge.

The abrasive article may be implemented such that the sharp portion is a sharp point.

The abrasive article may be implemented such that the radius of curvature of the sharp portion is less than 10 μm.

The abrasive article may be implemented such that the backing comprises nonwoven fibers.

The abrasive article may be implemented such that it further includes a binder.

The abrasive article may be implemented such that it further includes a grinding aid.

The abrasive article may be implemented such that it further includes a lubricant.

The abrasive article may be implemented such that the abrasive article comprises a disc.

The abrasive article may be implemented such that the abrasive article comprises a belt, a disc, or a sheet.

The abrasive article may be implemented such that the it also includes a make coat adhering the shaped abrasive particles to the backing.

The abrasive article may be implemented such that it also includes a size coat adhering the shaped abrasive particles to the make coat.

The abrasive article may be implemented such that at least one of the make coat and the size coat comprise a phenolic resin, an epoxy resin, a urea-formaldehyde resin, an acrylate resin, an aminoplast resin, a melamine resin, an acrylated epoxy resin, a urethane resin, or mixtures thereof.

The abrasive article may be implemented such that the at least one of the make coat and the size coat comprises a filler, a grinding aid, a wetting agent, a surfactant, a dye, a pigment, a coupling agent, an adhesion promoter, or a mixture thereof.

The abrasive article may be implemented such that the filler comprises calcium carbonate, silica, talc, clay, calcium metasilicate, dolomite, aluminum sulfate, or a mixture thereof.

The abrasive article may be implemented such that the backing comprises a flexible material.

The abrasive article may be implemented such that the backing is selected from the group consisting of: a polymeric film, a metal foil, a woven fabric, a knitted fabric, paper, a vulcanized fiber, a nonwoven, a foam, a screen, a laminate.

The abrasive article may be implemented such that the backing comprises an additive selected from the group consisting of: a colorant, a processing aid, a reinforcing fiber, a heat stabilizer, a UV stabilizer, and an antioxidant.

The abrasive article may be implemented such that it also includes a top coat.

The abrasive article may be implemented such that a majority of the plurality of the shaped abrasive particles are positioned such that a majority of the shaped abrasive particles share an orientation or share an inclination.

The abrasive article may be implemented such that substantially all the shaped abrasive particles share an orientation or share an inclination.

The abrasive article may be implemented such that the cutting portion of abrasives particles is substantially parallel to the backing.

The abrasive article may be implemented such that the sharp portions are substantially perpendicular to the backing.

1. A method of manufacturing a shaped abrasive particle, the method comprising:
filling a cavity of a tool with an abrasive particle precursor material, wherein the cavity has at least an interior surface that extends downward from a tool top surface at an angle;
leveling the abrasive particle precursor material such that a top surface of the abrasive particle precursor materials is flush with the tool surface, such that a sharp portion is formed along the intersection between the sloped wall of the tool cavity and the tool surface and the sharp portion is within the same plane as the tool surface; and
removing a dried abrasive particle precursor from the cavity of the tool, wherein the abrasive particle has a sharp portion formed along the intersection between the interior surface and the tool surface.

2. The method of claim 1, wherein the sharp portion comprises a sharp point.

3. The method of claim 1, wherein the sharp portion comprises a sharp edge.

4-6. (canceled)

7. The method of claim 1, wherein the sharp portion is created by the leveling step, such that the sharp portion is within the same plane as the tool surface, and wherein the sharp portion is an intersection between a first face corresponding to the opening of the tool cavity and a second face corresponding to an internal wall of the cavity.

8. The method of claim 1, wherein the interior surface is a first interior surface, and wherein the cavity also comprises a second interior surface.

9. The method of claim 1, wherein the surface of the tool is non-planar.

10-12. (canceled)

13. The method of claim 1, wherein a radius of curvature of the sharp portion is less than 10 μm.

14. The method of claim 1, wherein the cavity comprises a negative image of a structure such that the dried particle is a structure, wherein the structure is a polygonal structure or composite of polygonal structures.

15. (canceled)

16. (canceled)

17. The method of claim 1, wherein the polygonal structure comprises at least one triangle shaped face, and wherein the triangle shaped face comprises the sharp portion.

18-23. (canceled)

24. The method of claim 1, wherein filling comprises overfilling and wherein leveling comprises removing an excess of the abrasive precursor material.

25. The method of claim 1, wherein the leveling step comprises applying a leveling tool to the surface of the tool structure.

26. The method of claim 25, wherein the leveling tool comprises a feature configured to mate with a non-planar surface of the tool.

27. A shaped abrasive particle comprising:
a first face and a second face, the first face and the second face separated by a thickness, wherein the second face has a different shape than the first face;
a sharp portion defined by an interface between a third face and the first face, wherein the third face extends from the second face to the first face, wherein the second face is polygonal in shape.

28. The shaped abrasive particle of claim 27, wherein the sharp portion forms an edge of the first face.

29-32. (canceled)

33. The shaped abrasive particle of claim 27, wherein the angle between the third face and the second face is at least 135° within the sharp portion.

34. The shaped abrasive particle of claim 27, wherein the angle between the third face and the first face is less than 80°.

35-39. (canceled)

40. The shaped abrasive particle of claim 27, wherein the sharp portion comprises a sharp point.

41. (canceled)

42. (canceled)

43. The shaped abrasive particle of claim 27, wherein the shaped abrasive particle is a self-orienting particle such that, when dropped on a substrate, the sharp portion points away from the substrate.

44-51. (canceled)

52. The shaped abrasive particle of claim 27, wherein the first face has a different area than the second face.

53-57. (canceled)

58. The shaped abrasive particle of claim 27, wherein an angle formed at the intersection between the first face and the third face is an acute angle.

59-104. (canceled)
